(19) United States
(12) Patent Application Publication
(10) Pub. No.: US 2015/0330602 A1
(43) Pub. Date: Nov. 19, 2015

(54) WAVE LENGTH CONVERSION MEMBER, BACK LIGHT UNIT, LIQUID CRYSTAL DISPLAY DEVICE, AND QUANTUM DOT-CONTAINING POLYMERIZABLE COMPOSITION

(71) Applicant: FUJIFILM Corporation, Tokyo (JP)

(72) Inventors: Takashi YONEMOTO, Kanagawa (JP); Hiroyuki YONEYAMA, Kanagawa (JP); Tatsuya OBA, Kanagawa (JP); Makoto KAMO, Kanagawa (JP); Yutaka ADEGAWA, Kanagawa (JP)

(73) Assignee: FUJIFILM Corporation, Tokyo (JP)

(21) Appl. No.: 14/713,159

(22) Filed: May 15, 2015

(30) Foreign Application Priority Data
May 19, 2014 (JP) 2014-103851
Apr. 23, 2015 (JP) 2015-088632

(51) Int. Cl. F21V 9/16; C09K 11/70; C09K 11/02; F21V 8/00

(52) U.S. Cl. CPC F21V 9/16; G02B 6/0026; G02B 6/005; G02B 6/0073; C09K 11/703; C09K 11/025

(57) ABSTRACT

A wavelength conversion member including a wavelength conversion layer comprising a quantum dot, wherein the wavelength conversion layer includes an organic matrix, and the organic matrix contains a polymer and one or more of compounds selected from the group consisting of compounds represented by general formula (1) and the like; and a quantum dot-containing polymerizable composition containing a quantum dot, a radical polymerizable compound, and one or more of compounds selected from the group consisting of compounds represented by general formula (1) and the like are provided.

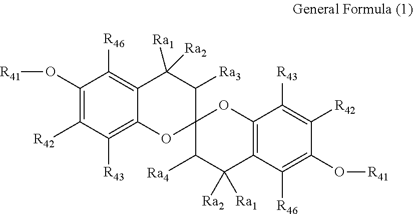

The wavelength conversion member has an excellent light resistance and the composition has an excellent photocurability which enables a production of a wavelength conversion member containing a quantum dot which has a less tendency to lower its light emission intensity.

### CROSS-REFERENCE TO RELATED APPLICATIONS

The present application claims priorities under 35 U.S.C §119 to Japanese Patent Applications No. 2014-103851 filed on May 19, 2014 and No. 2015-088632 filed on Apr. 23, 2015, the entire contents of which are incorporated by reference into the present application.

### TECHNICAL FIELD

The present invention relates to a wave length conversion member. The present invention also relates to a back light unit including the wave length conversion member, and a liquid crystal display device including the back light unit. The present invention further relates to a quantum dot-containing polymerizable composition that can be used for a production of the wave length conversion member.

### BACKGROUND ART

Use of flat panel display such as a liquid crystal display device (hereinafter also referred to as “LCD”) has been enlarged year by year as a space-saving image display device because of small power consumption. The liquid crystal display device is constituted of at least a backlight and a liquid crystal cell, and usually, further includes a polarizing plate on a backlight side, a polarizing plate on a viewing side.

In the flat panel display market, the enhancement of color reproducibility is being developed as an improvement of the LCD performance. With regard to this point, in recent years, a Quantum Dot (QD, also referred to as quantum point) as a light emitting material has drawn many people's attention (see Patent Document 1). For example, when exciting light enters a wavelength conversion member containing a quantum dot from a backlight, the quantum dot is excited to emit fluorescent light. By using quantum dots having different light emission characteristics, emission of red light, green light and blue light can be achieved to thereby embody white light. Since the fluorescent light emitted by a quantum dot has a small half width, the obtained white light has a high brightness and is excellent in color reproducibility. Due to the advancement of the three wavelength light source technique using such quantum dots, the range of color reproducibility is enlarged from 72% to 100% in terms of the present TV standard ratio (FHD (Full High Definition)), NTSC (National Television System Committee)).

### CITATION LIST

Patent Literature 1:US2012/0113672A1
Patent Literature 2:WO2011/031876
Patent Literature 3:WO2013/078252

### SUMMARY OF THE INVENTION

The wavelength conversion member containing a quantum dot has a problem in which the light emission intensity becomes lower with the lapse of time. This problem is considered to be derived from low light resistance of a quantum dot, specifically lowering of the light emission intensity by photo oxidation reaction when oxygen comes into contact with the quantum dot, and the like. In this regard, Patent Document 1 proposes a lamination of a barrier film on a layer containing a quantum dot in order to protect the quantum dot from oxygen, and the like.

Although the intrusion of oxygen from a lamination surface side of the film can be prevented by the lamination of a barrier film, the intrusion of oxygen from side surfaces cannot be prevented. Even when the wavelength conversion member is produced in a long film form so as to have barrier films on the both side, the layer containing a quantum dot is exposed to the ambient air at cut side surfaces of the wavelength conversion-member that is to be cut into a desired size, and the light emission intensity of the quantum dot is lowered from the cut side surfaces.

On the other hand, in Patent Documents 2 and 3, a configuration in which the film containing a quantum dot contains a light emission stabilizing agent is disclosed. Since the light emission stabilizing agent exists in the layer containing a quantum dot, it is possible to reduce an influence such as, for example, the above-described oxygen intrusion from the side surface.

However, it is necessary to add the light emission stabilizing agent directly to the material which forms the wavelength conversion layer containing a quantum dot. The wavelength conversion layer can be formed by curing reaction of a composition containing a quantum dot and polymerizable compound. However, the addition of the light emission stabilizing agent could give an influence on the above curing reaction.

In consideration of the above matters, an object of the present invention is to provide a wavelength conversion member which has a less tendency to lower its light emission intensity as a wavelength conversion member containing a quantum dot. Furthermore, the object of the present invention is to provide a composition having an excellent photocurability which enables a production of a wavelength conversion member containing a quantum dot which has a less tendency to lower its light emission intensity. Moreover, the object of the present invention is to provide a highly durable backlight unit, and a liquid crystal display device.

In order to solve the above-described problem, the present inventors have made incentive studies on an additive which is added to the composition containing a quantum dot together with the polymerizable compound to thereby stabilize light emission of the quantum dot, and which also does not inhibit the polymerization of the coexisting polymerizable compound; and have completed the present invention.

Namely, the present invention provides the following [1] to [17].

[1] A wavelength conversion member including a wavelength conversion layer containing a quantum dot which is excited by exciting light to emit fluorescence, wherein
the wavelength conversion layer includes an organic matrix,
the organic matrix includes a polymer and one or more of compounds selected from the group consisting of compounds represented by any of the following general formulae (1) to (6);

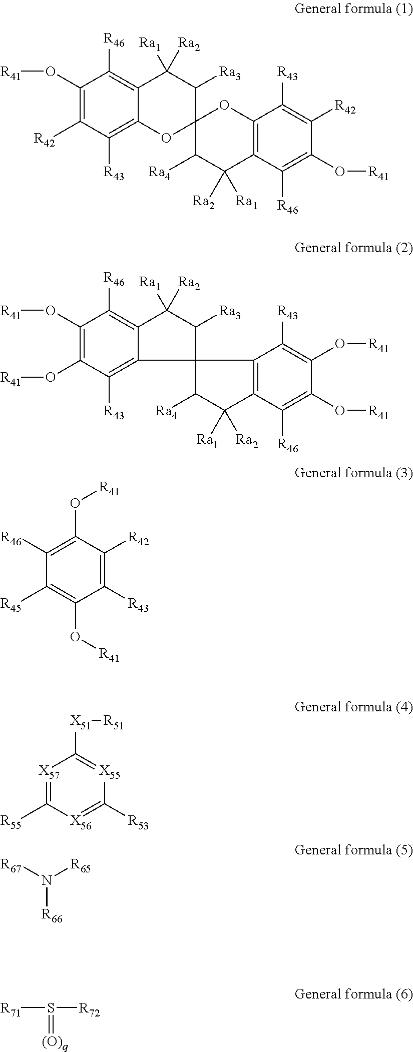

in general formulae (1) to (3), R₄₁ represents an aliphatic group, an aryl group, a heterocyclic group, an acyl group, an aliphatic oxycarbonyl group, an aryloxycarbonyl group, an aliphatic sulfonyl group, an aryl sulfonyl group, a phosphoryl group or —Si(R₄₇)(R₄₈)(R₄₉), each of R₄₇, R₄₈ and R₄₉ represents independently an aliphatic group, an aryl group, an aliphatic oxy group or an aryloxy group, each of R₄₂ to R₄₆ represents independently hydrogen atom or a substituent, and each of Rₐ₁ to Rₐ₄ represents independently hydrogen or an aliphatic group,
in general formula (4), R₅₁ represents hydrogen atom, an aliphatic group, an aryl group, a heterocyclic group, an acyl group, an aliphatic oxycarbonyl group, an aryloxycarbonyl group, an aliphatic sulfonyl group, an aryl sulfonyl group, a phosphoryl group or —Si(R₅₈)(R₅₉)(R₆₀), each of R₅₈, R₅₉ and R₆₀ represents independently an aliphatic group, an aryl group, an aliphatic oxy group or an aryloxy group, X₅₁ represents —O— or —N(R₅₇)—, R₅₇ has the same definition as that of R₅₁, X₅₅ represents —N═ or —C(R₅₂)=, X₅₆ represents —N═ or —C(R₅₄)=, X₅₇ represents —N═ or —C(R₅₆)=, each of R₅₂, R₅₃, R₅₄, R₅₅ and R₅₆ represents independently hydrogen atom or a substituent, R₅₁ and R₅₂, R₅₇ and R₅₆, and R₅₁ and R₅₇ may be bonded to each other to form a 5- to 7-membered ring, R₅₂ and R₅₃, R₅₃ and R₅₄ may be bonded to each other to form a 5- to 7-membered ring or a spiro ring, a bicycle ring, provided that not all of R₅₁ to R₅₇ are hydrogen atoms at the same time, the total number of carbon atoms of the compounds represented by general formula (4) is 10 or more, and the compounds represented by general formula (4) are not the compounds represented by any of general formulae (1) to (3),
in general formula (5), each of R₆₅ and R₆₆ represents independently hydrogen atom, an aliphatic group, an aryl group, an acyl group, an aliphatic oxycarbonyl group, an aryloxycarbonyl group, a carbamoyl group, an aliphatic sulfonyl group or an aryl sulfonyl group, R₆₇ represents hydrogen atom, an aliphatic group, an aliphatic oxy group, an aryloxy group, an aliphatic thio group, an aryl thio group, an acyloxy group, an aliphatic oxycarbonyloxy group, an aryloxycarbonyloxy group, a substituted amino group, a heterocyclic group or hydroxyl group, R₆₅ and R₆₆, R₆₆ and R₆₇, and R₆₅ and R₆₇ may be bonded to each other to form 5- to 7-membered ring, but do not form a 2,2,6,6-tetraalkylpiperidine skeleton, not both of R₆₅ and R₆₆ are hydrogen atoms at the same time, and the total number of carbon atoms of R₆₅ and R₆₆ is 7 or more, in general formula (6), R₇₁ represents hydrogen atom, an aliphatic group, an aryl group, a heterocyclic group, Li, Na or K, R₇₂ represents an aliphatic group, an aryl group or a heterocyclic group, R₇₁ and R₇₂ may be bonded to each other to form a 5- to 7-membered ring, q represents 0, 1 or 2, provided that the total number of carbon atoms of R₇₁ and R₇₂ is 10 or more.
[2] The wavelength conversion member according to the above [1], wherein the polymer is a polymer of a (meth)acrylate monomer.
[3] The wavelength conversion member according to the above [1] or [2], wherein the polymer is a polymer of a mono-functional (meth)acrylate monomer and a poly-functional (meth) acrylate monomer.
[4] The wavelength conversion member according to the above [1] to [3], including a base material, and at least one surface of the wavelength conversion layer is directly in contact with the base material.
[5] The wavelength conversion member according to the above [4], including two base materials each of which is a barrier film including an inorganic layer, and including the wavelength conversion layer between the two barrier films.
[6] The wavelength conversion member according to the above [5], wherein each of the two barrier films is directly in contact with the wavelength conversion layer at the inorganic layer.
[7] The wavelength conversion member according to the above [5] or [6], wherein an oxygen permeability of each of the barrier film is 1 cm³/(m²·day·atm) or less.
[8] The wavelength conversion member according to any one of the above [1] to [7], wherein the wavelength conversion layer contains a first quantum dot having a emission center wavelength in 500 nm to 600 nm, and a second quantum dot having a emission center wavelength in 600 to 680 nm.
[9] A backlight unit including at least the wavelength conversion member according to any one of the above [1] to [8] and a light source.
[10] The backlight unit according to the above [9], wherein the light source is a blue light emission diode or an ultraviolet ray emission diode.
[11] The backlight unit according to the above [9] or [10], further including a light guide plate, wherein the wavelength conversion member is arranged on a path of light emitted from the light guide plate.
[12] The backlight unit according to the above [9] or [10], further including a light guide plate, wherein
the wavelength conversion member is arranged between the light guide plate and the light source.
[13] A liquid crystal display device including at least the backlight unit according to any one of the above [9] to [12] and a liquid crystal cell.
[14] A quantum dot-containing polymerizable composition containing a quantum dot which is excited by exciting light to emit fluorescence, a radical polymerizable compound, and one or more of compounds selected from the group consisting of compounds represented by the following general formulae (1) to (6);

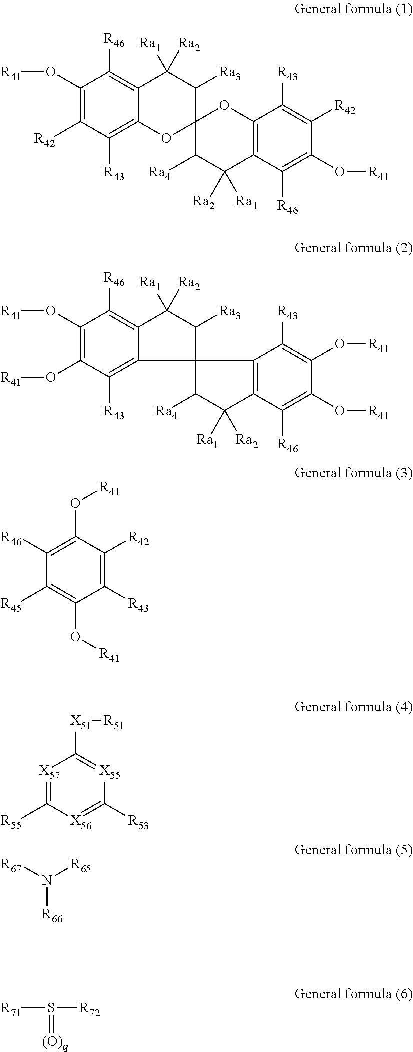

In general formulae (1) to (3), R₄₁ represents an aliphatic group, an aryl group, a heterocyclic group, an acyl group, an aliphatic oxycarbonyl group, an aryloxycarbonyl group, an aliphatic sulfonyl group, an aryl sulfonyl group, a phosphoryl group or —Si(R₄₇)(R₄₈)(R₄₉), each of R₄₇, R₄₈ and R₄₉ represents independently an aliphatic group, an aryl group, an aliphatic oxy group or an aryloxy group, each of R₄₂ to R₄₆ represents independently hydrogen atom or a substituent, and each of Rₐ₁ to Rₐ₄ represents independently hydrogen atom or an aliphatic group,

in general formula (4), R₅₁ represents hydrogen atom, an aliphatic group, an aryl group, a heterocyclic group, an acyl group, an aliphatic oxycarbonyl group, an aryloxycarbonyl group, an aliphatic sulfonyl group, an aryl sulfonyl group, a phosphoryl group or —Si(R₅₈)(R₅₉)(R₆₀), each of R₅₈, R₅₉ and R₆₀ represents independently an aliphatic group, an aryl group, an aliphatic oxy group or an aryloxy group, X₅₁ represents —O— or —N(R₅₇)—, R₅₇ is the same as R₅₁, X₅₅ represents —N═ or —C(R₅₂)=, X₅₆ represents —N═ or —C(R₅₄)=, X₅₇ represents —N═ or —C(R₅₆)=, each of R₅₂, R₅₃, R₅₄, R₅₅ and R₅₆ represents independently hydrogen atom or a substituent, R₅₁ and R₅₂, R₅₇ and R₅₆, and R₅₁ and R₅₇ may be bonded to each other to form a 5- to 7-membered ring, R₅₂ and R₅₃, and R₅₃ and R₅₄ may be bonded to each other to form a 5- to 7-membered ring or a spiro ring, a bicycle ring, provided that not all of R₅₁ to R₅₇ are hydrogen atoms at the same time, the total number of carbon atoms of the compounds represented by general formula (4) is 10 or more, and the compounds represented by general formula (4) are not the compounds represented by any of general formulae (1) to (3),
in general formula (5), each of R₆₅ and R₆₆ represents independently hydrogen atom, an aliphatic group, an aryl group, an acyl group, an aliphatic oxycarbonyl group, an aryloxycarbonyl group, a carbamoyl group, an aliphatic sulfonyl group or an aryl sulfonyl group, R₆₇ represents hydrogen atom, an aliphatic group, an aliphatic oxy group, an aryloxy group, an aliphatic thio group, an aryl thio group, an acyloxy group, an aliphatic oxycarbonyloxy group, an aryloxycarbonyloxy group, a substituted amino group, a heterocyclic group or a hydroxyl group, R₆₅ and R₆₆, R₆₆ and R₆₇, and R₆₅ and R₆₇ may be bonded to each other to form 5- to 7-membered ring, but do not form a 2,2,6,6-tetraalkylpiperidine skeleton, not both of R₆₅ and R₆₆ are hydrogen atoms at the same time, and the total number of carbon atoms of R₆₅ and R₆₆ is 7 or more, in general formula (6), R₇₁ represents hydrogen atom, an aliphatic group, an aryl group, a heterocyclic group, Li, Na or K, R₇₂ represents an aliphatic group, an aryl group or a heterocyclic group, R₇₁ and R₇₂ may be bonded to each other to form a 5- to 7-membered ring, q represents 0, 1 or 2, provided that the total number of carbon atoms of R₇₁ and R₇₂ is 10 or more.
[15] The quantum dot-containing polymerizable composition according to the above [14], containing a (meth)acrylate monomer as the radical polymerizable compound.
[16] The quantum dot-containing polymerizable composition according to the above [15], containing a mono-functional (meth)acrylate monomer and a poly-functional (meth) acrylate monomer as the radical polymerizable compound.
[17] The quantum dot-containing polymerizable composition according to the above [16], wherein the mono-functional (meth)acrylate monomer has a long-chain alkyl group of 4 to 30 carbon atoms.

### Effects of the Invention

The present invention provides a wavelength conversion-member which has a less tendency to lower its light emission intensity as a wavelength conversion member containing a quantum dot. Furthermore, the present invention provides a quantum dot-containing polymerizable composition which has an excellent photocurability and which enables a production of a wavelength conversion member containing a quantum dot, which has a less tendency to lower its light emission intensity.

### BRIEF DESCRIPTION OF DRAWINGS

FIGS. 1(a) and 1(b) are explanatory views showing one example of the backlight unit including a wavelength conversion member.

FIG. 2 is a schematic construction view of one example of manufacturing apparatus of the wavelength conversion member.

FIG. 3 is a partially enlarged view of the manufacturing apparatus shown in FIG. 2.

FIG. 4 shows one example of a liquid crystal display device.

### MODES OF CARRYING OUT INVENTION

In the following, explanation may be carried out on the basis of typical embodiments of the present invention, but the present invention is not limited to these embodiments. In the present invention and the description, the numerical range represented by “to” means the range including the numerical values before and after the “to” as the upper limit and the lower limit.

In the present description, “half width” of a peak means a width of the peak at ½ height of the peak. A light having an emission center wavelength within the wavelength range of 400 to 500 nm, preferably within the range of 430 to 480 nm is referred to as a blue light, a light having an emission center wavelength within the range of 500 to 600 nm is referred to as a green light, a light having an emission center wavelength within the range of 600 to 680 nm is referred to as a red light.

In the present description, “a polymerizable composition” is a composition containing at least one polymerizable compound, and has a property of being cured by being subjected to polymerization treatment such as light irradiation and heating. In addition, “a polymerizable compound” is a compound containing one or more polymerizable groups in one molecule. The polymerizable group is a group capable of being involved in a polymerization reaction. Details will be explained below.

Furthermore, in the present description, descriptions relating to angle such as orthogonal include a tolerance accepted in the technical field of the present invention. For example, the tolerance means being within the range of the exact angle less than ±10°, the tolerance from the exact angle being preferably 5° or less, more preferably 3° or less.

### [Wavelength Conversion Member]

A wavelength conversion member may have a function to convert the wavelength of at least a part of incident light and emit a light of a wavelength different from that of the part of the incident light. The shape of the wavelength conversion member is not particularly limited. For example, the wavelength conversion member may be an optional form such as a sheet, a film, or a bar. The wavelength conversion member may include a wavelength conversion layer containing a quantum dot. The wavelength conversion layer is a layer that includes a quantum dot and an organic matrix. A wavelength conversion member can be used as a constituent member of a backlight unit of a liquid crystal display device.

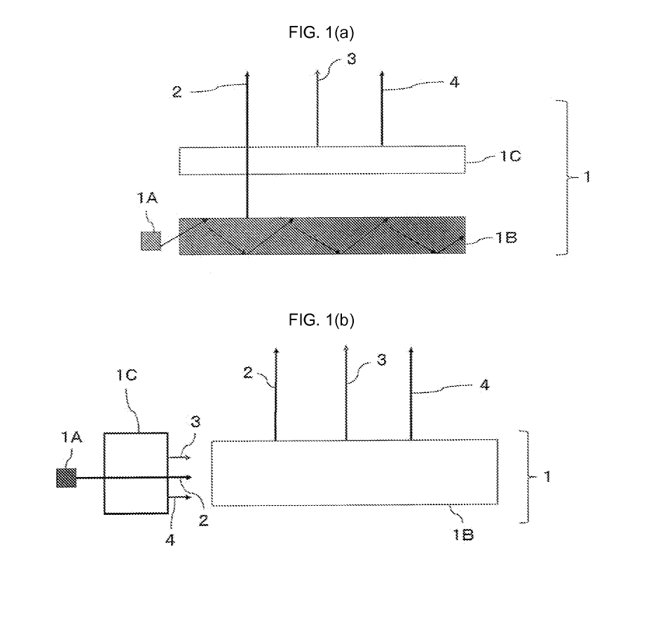

FIGS. 1(a) and 1(b) are explanatory views showing one example of a backlight unit 1 containing a wavelength conversion member. In FIGS. 1(a) and 1(b), the backlight unit 1 is provided with a light source 1A and a light guide plate 1B for obtaining a surface light source. In the example shown in FIG. 1(a), the wavelength conversion member is arranged on a path of light emitted from the light guide plate. On the other hand, in the example shown in FIG. 1(b), the wavelength conversion member is arranged between the light guide plate and the light source.

In the example shown in FIG. 1(a), the light emitted from the light guide plate 1B enters a wavelength conversion member 1C. In the example shown in FIG. 1(a), light 2 emitted from the light source 1A arranged at an edge portion of the light guide plate 1B is blue light, and is emitted from the side of a liquid crystal cell (not shown) of the light guide plate 1B to the liquid crystal cell. The wavelength conversion member 1C arranged on the path of the light (blue light 2) emitted from the light guide plate 1B contains at least a quantum dot A which emits red light 4 upon excitation by the blue light 2, and a quantum dot B which emits green light 3 upon excitation by the blue light 2. From the backlight unit 1, the excited green light 3 and red light 4 and the blue light 2 transmitted through the wavelength conversion member 1C are thus emitted. The emission of the red light, the green light and the blue light as above can realize white light.

The example shown in FIG. 1(b) is the same as in the embodiment shown in FIG. 1(a) except that the arrangements of the wavelength conversion member and the light guide plate are different from each other. In the example shown in FIG. 1(b), the excited green light 3 and red light 4 and the blue light 2 transmitted through the wavelength conversion member 1C are emitted from the wavelength conversion member 1C and enter the light guide plate to thereby achieve a surface light source.

### (Wavelength Conversion Layer)

The wavelength conversion member includes at least a wavelength conversion layer containing a quantum dot. The wavelength conversion layer includes a quantum dot in an organic matrix. In the present description, the organic matrix means the part not including quantum dots and including the polymer.

The wavelength conversion layer can be prepared from a quantum dot-containing polymerizable composition that contains a quantum dot, a radical polymerizable compound, and a compound represented by any one of general formulae (1) to (6). The wavelength conversion layer can optionally contain, in addition to the above described components, one or more other components.

The polymer may be a polymer obtained by polymerizing the radical polymerizable compound. The shape of the wavelength conversion layer is not particularly limited. For example, the wavelength conversion layer may be an optional form such as a sheet, a film, or a bar.

### (Quantum Dot-Containing Polymerizable Composition)

A quantum dot-containing polymerizable composition contains a quantum dot and a polymerizable compound. As the polymerizable compound, a radical polymerizable compound is used and the quantum dot-containing polymerizable composition contains a compound represented by any one of general formulae (1) to (6). The quantum dot-containing polymerizable composition may contain a polymerization initiator, a silane coupling agent or the like.

### (Quantum Dot)

A quantum dot is excited by exciting light to emit fluorescence. The wavelength conversion layer contains at least one type of quantum dot, and can contain two or more different types of quantum dots. Examples of known quantum dot include a quantum dot A having an emission center wavelength within a wavelength range of 600 nm to 680 nm, a quantum dot B having an emission center wavelength within a wavelength range of 500 nm to 600 nm, and a quantum dot C having an emission center wavelength within a wavelength range of 400 nm to 500 nm. By being excited by exciting light, the quantum dot A emits a red light, the quantum dot B emits a green light, and the quantum dot C emits a blue light. For example, when blue light as exciting light enters to a wavelength conversion layer containing the quantum dot A and the quantum dot B, white light can be realized by red light emitted from the quantum dot A, green light emitted from the quantum dot B and the blue light transmitted through the wavelength conversion layer, as shown in FIG. 1. Alternatively, when an ultraviolet light as exciting light enters to a wavelength conversion layer containing quantum dots A, B and C, white light can be realized by red light emitted from the quantum dot A, green light emitted from the quantum dot B and blue light emitted from the quantum dot C. As the quantum dot, any materials prepared by known methods and commercially available products can be used without limitation. For the quantum dot, Paragraphs 0060 to 0066 of JP 2012-169271 As can be referred to, for example, but is not limited to the compounds described in the document. The emitted wavelength of the quantum dot can usually be regulated by composition and size of particles, and composition and size.

The quantum dot may be added to the above polymerizable composition in the form of particle or may be added in the dispersion obtained by being dispersed in a solvent. It is preferable to add a quantum dot in the form of dispersion because agglomeration of the quantum dot particles is suppressed. The solvent to be used is not particularly limited. The quantum dot can be added in an amount of 0.01 to 10 parts by mass relative to 100 parts by mass of the total amount of the quantum dot-containing polymerizable composition.

The radial polymerizable compound is not particularly limited. A (meth)acrylate compound such as mono-functional or poly-functional (meth)acrylate monomer, a polymer thereof, a prepolymer thereof, or the like is preferable from the viewpoints of transparency, adhesiveness, and the like of the cured film after curing. In the present description of “(meth)acrylate” means both or one of acrylate and methacrylate. The same also applies to “(meth)acryloyl” and the like.

Examples of the mono-functional (meth)acrylate compound can include acrylic acid and methacrylic acid, a derivative thereof, more specifically a compound having one polymerizable unsaturated bond of (meth)acrylic acid ((meth)acryloyl group) in one molecule. The specific examples thereof are listed below, and the present invention is not limited to these.

The examples include an alkyl (meth)acrylate having an alkyl group of 1 to 30 carbon atoms such as methyl (meth)acrylate, n-butyl (meth)acrylate, isobutyl (meth)acrylate, 2-ethylhexyl (meth)acrylate, isononyl (meth)acrylate, n-octyl (meth)acrylate, lauryl (meth)acrylate, and stearyl (meth)acrylate; an arylalkyl (meth)acrylate having an arylalkyl group of 7 to 20 carbon atoms such as benzyl (meth)acrylate; an alkoxyalkyl (meth)acrylate having an alkoxyalkyl group of 2 to 30 carbon atoms such as butoxyethyl (meth)acrylate; an aminoalkyl (meth)acrylate having a (mono-alkyl or di-alkyl) aminoalkyl group of 1 to 20 total carbon atoms such as N,N-dimethylaminoethyl (meth)acrylate; a (meth)acrylate of polyalkylene glycol alkyl ether having an alkylene chain of 1 to 10 carbon atoms and a terminal alkyl ether of 1 to 10 carbon atoms such as (meth)acrylate of diethylene glycol ethyl ether, (meth)acrylate of triethylene glycol butyl ether, (meth)acrylate of tetraethylene glycol monomethyl ether, (meth)acrylate of hexaethylene glycol monomethyl ether, monomethyl ether (meth)acrylate of octaethylene glycol, monomethyl ether (meth)acrylate of nonaethylene glycol, monomethyl ether (meth)acrylate of dipropylene glycol, monomethyl ether (meth)acrylate of heptapropylene glycol, and monoethyl ether (meth)acrylate of tetraethylene glycol; a (meth)acrylate of polyalkylene glycol aryl ether having an alkylene chain of 1 to 30 carbon atoms and a terminal aryl ether of 6 to 20 carbon atoms such as (meth)acrylate of hexaethylene glycol phenyl ether; a (meth)acrylate of 4 to 30 total carbon atoms having a cycloaliphatic structure such as cyclohexyl (meth)acrylate, dicyclopentanyl (meth)acrylate, isobornyl (meth)acrylate, and methylene oxide adduct cyclodecatriene (meth)acrylate; a fluorinated alkyl (meth)acrylate of 4 to 30 total carbon atoms such as heptadecafluorodecyl (meth)acrylate; a (meth)acrylate having hydroxyl group such as 2-hydroxyethyl (meth)acrylate, 3-hydroxypropyl (meth)acrylate, 4-hydroxybutyl (meth)acrylate, triethylene glycol mono(meth)acrylate, tetraethylene glycol mono(meth)acrylate, hexaethylene glycol mono(meth)acrylate, octapropylene glycol mono(meth)acrylate, and mono- or di-(meth)acrylate of glycerol; a (meth)acrylate having glycidyl group such as glycidyl (meth)acrylate; a polyethylene glycol mono(meth)acrylate having an alkylene chain of 1 to 30 carbon atoms such as tetraethylene glycol mono(meth)acrylate, hexaethylene glycol mono(meth)acrylate, and octapropylene glycol mono(meth)acrylate; a (meth)acrylamide such as (meth)acrylamide, N,N-dimethyl (meth)acrylamide, N-isopropyl (meth)acrylamide, 2-hydroxyethyl (meth)acrylamide, and acryloylmorpholine, and the like.

The mono-functional (meth)acrylate compound to be used is preferably an alkyl (meth)acrylate of 4 to 30 carbon atoms, and more preferably an alkyl (meth)acrylate of 12 to 22 carbon atoms from the viewpoint of enhancing dispersion of quantum dots. The more the dispersion of quantum dots is enhanced, the more the amount of light going directly from the wavelength conversion layer to the emission surface is increased, which is effective for enhancing a front brightness and a front contrast. Specifically, as the mono-functional (meth)acrylate compound, butyl (meth)acrylate, octyl (meth)acrylate, lauryl (meth)acrylate, oleyl (meth)acrylate, stearyl (meth)acrylate, behenyl (meth)acrylate, butyl (meth)acrylamide, octyl (meth)acrylamide, lauryl (meth)acrylamide, oleyl (meth)acrylamide, stearyl (meth)acrylamide, behenyl (meth)acrylamide, and the like are preferable. Among them, lauryl (meth)acrylate, oleyl (meth)acrylate, stearyl (meth)acrylate are particularly preferable.

In addition, the mono-functional (meth)acrylate compound to be preferably used is a mono-functional (meth)acrylate compound having one or more groups selected from the group consisting of hydroxyl group and an aryl group from the viewpoint of further reducing of the oxygen permeability coefficient of the wavelength conversion layer and enhancing adhesiveness to the other layer or member.

The group that the above-described mono-functional (meth)acrylate compound has is preferably hydroxyl group and phenyl group. Specific examples of the preferred compound include benzyl acrylate, phenoxyethyl acrylate, phenoxydiethylene glycol acrylate, 1,4-cyclohexanedimethanol mono-acrylate, 2-hydroxy-3-phenoxypropyl acrylate, and 4-hydroxybutyl acrylate.

Together with a monomer having one polymerizable unsaturated bond of the (meth) acrylic acid ((meth)acryloyl group) in one molecule, a poly-functional (meth)acrylate monomer having two or more (meth)acryloyl groups in one molecule ca be used.

Among the two- or more-functional (meth)acrylate monomers, preferable examples of two-functional (meth)acrylate monomer include neopentyl glycol di(meth)acrylate, 1,9-nonane diol di(meth)acrylate, tripropylene glycol di(meth)acrylate, ethylene glycol di(meth)acrylate, tetraethylene glycol di(meth)acrylate, hydroxylpivalate neopentyl glycol di(meth)acrylate, polyethylene glycol di(meth)acrylate, di dicyclopentenyl (meth)acrylate, dicyclopentenyloxyethyl (meth)acrylate, dicyclopentenyl di(meth)acrylate, and the like.

Furthermore, among the two- or more-functional (meth)acrylate monomers, preferable examples of three- or more-functional (meth)acrylate monomer include ECH-modified glycerol tri(meth)acrylate, EO-modified glycerol tri(meth)acrylate, PO-modified glycerol tri(meth)acrylate, pentaerythritol triacrylate, pentaerythritol tetraacrylate, EO-modified phosphoric acid triacrylate, trimethylolpropane tri(meth)acrylate, caprolactone-modified trimethylolpropane (meth)acrylate, EO-modified trimethylolpropane tri(meth)acrylate, PO-modified trimethylolpropane tri (meth)acrylate, tris(acryloxyethyl) isocyanurate, dipentaerythritol hexa(meth)acrylate, dipentaerythritol penta(meth)acrylate, caprolactone-modified dipentaerythritol hexa(meth)acrylate, dipentaerythritol hydroxypenta(meth)acrylate, alkyl-modified dipentaerythritol penta(meth)acrylate, dipentaerythritol poly(meth)acrylate, alkyl-modified dipentaerythritol tri(meth)acrylate, ditrimethylolpropane tetra(meth)acrylate, pentaerythritol ethoxytetra(meth)acrylate, pentaerythritol tetra(meth)acrylate, and the like.

Also, the quantum dot-containing polymerizable composition preferably contains a (meth)acrylate monomer having an Mw/F, namely a ratio of a weight average molecular weight Mw to the number F of (meth)acryloyl groups per one molecule, of 200 or less as the radically polymerizable compound. The Mw/F is more preferably 150 or less, most preferably 100 or less. The reason is because an oxygen permeability of the wavelength conversion layer formed by curing the quantum dot-containing polymerizable composition can be reduced by using the (meth)acrylate monomer having a small Mw/F, and thus the light resistance of the wavelength conversion member can be enhanced. Utilization of the (meth)acrylate monomer having a small Mw/F is also preferable from the viewpoint that a crosslinking density of the polymer in the wavelength conversion layer can be made higher and breakage of the wavelength conversion layer can be prevented.

In the present description, the weight-average molecular weight is a value obtained by calculating a measured value by gel permeation chromatography (Gel Permeation Chromatography; GPC) according to polystyrene conversion. One example of the specific measuring conditions of the weight-average molecular weight includes the following measuring conditions. The weight-average molecular weight mentioned in the Examples described later is a value measured by the following conditions.

GPC device: HLC-8120 (manufactured by TOSO)

Column: TSK gel Multipore HXL-M (manufactured by TOSO 7.8 mm ID (inside diameter)×30.0 cm)

Eluent: Tetrahydrofuran (THF)

Specific examples of the (meth)acrylate monomer having an Mw/F of 200 or less include pentaerythritol triacrylate, pentaerythritol tetraacrylate, tri methylolpropane trimethacrylate, dipentaerythritol hexaacrylate, tricyclodecanedimethanol diacrylate, and the like.

A use amount of the poly-functional (meth)acrylate monomer relative to 100 parts by mass of the total amount of the polymerizable compound contained in the quantum dot-containing polymerizable composition is preferably 5 parts by mass or more from the viewpoint of strength of a coating film, 95 parts by mass or less from the viewpoint of inhibiting gelation of the composition.

In addition, the radically polymerizable compound is contained in an amount of 10 to 99.9 parts by mass relative to 100 parts by mass of the total amount of the quantum dot-containing polymerizable composition, more preferably 50 to 99.9 parts by mass, and particularly preferably 92 to 99 parts by mass.

### (Compound Represented by any of General Formulae (1) to (6))

The present inventors have found that the light emission of a quantum dot can be stabilized by adding one or more compounds selected from the group consisting of the compounds represented by any of general formulae (1) to (6) to the composition containing a quantum dot together with the polymerizable compound. The compounds represented by any of general formulae (1) to (6) is a compound described in Paragraphs 0114 to 0180 of JP 2004-302302, and is known as compound having a function as a light stability-improving agent of dye. In the wavelength conversion layer, the compound represented by any of general formulae (1) to (6) is considered to have an improving effect of interacting with a particle, in the ground state and/or excited state of the particle, on the oxidative deactivation, at the time of light irradiation of the quantum dot which deteriorates by oxygen entering from the outside, or is considered to act on a deactivation of a radical and deactivation of a peroxide in the vicinity of the quantum dot. Furthermore, the compound represented by any of general formulae (1) to (6) does not inhibit the polymerization of the radically polymerizable compound, and thus the curing of the quantum dot-containing polymerizable composition containing the radically polymerizable compound is excellent even when the compound represented by any of general formulae (1) to (6) is added. For example, a compound in which a phenol type hydroxyl group is etherized does not exert a harmful effect such as inhibition of the polymerization of the radical polymerizable compound, and is particularly effective.

Hereinafter, each compound represented by any of general formulae (1) to (6) will be explained.

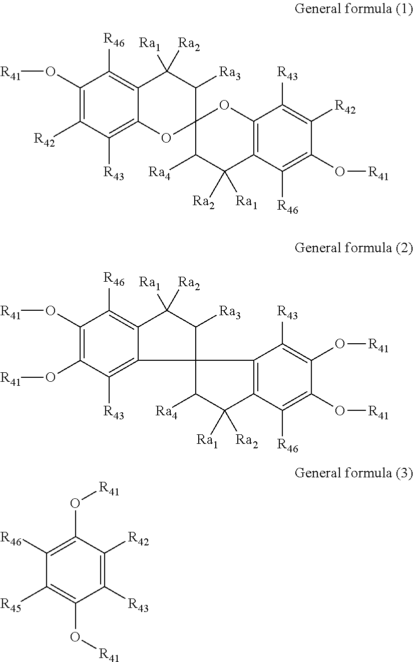

R₄₁ represents an aliphatic group, an aryl group, a heterocyclic group, an acyl group, an aliphatic oxycarbonyl group, an aryloxycarbonyl group, an aliphatic sulfonyl group, an aryl sulfonyl group, a phosphoryl group or —Si(R₄₇)(R₄₈)(R₄₉). Here, each of R₄₇, R₄₈ and R₄₉ represents independently an aliphatic group, an aryl group, an aliphatic oxy group or an aryloxy group. R₄₂ to R₄₆ represent hydrogen atom or a substituent. Each of Rₐ₁ to Rₐ₄ represents hydrogen atom or an aliphatic group (for example, methyl, ethyl).

With respect to the compound represented by any of general formulae (1) to (3), preferred substituent is explained below.

In general formulae (1) to (3), preferably R₄₁ is an aliphatic group, an acyl group, an aliphatic oxycarbonyl group, an aryloxycarbonyl group or a phosphoryl group, and each of R₄₂, R₄₃, R₄₅ and R₄₆ is independently hydrogen atom, an aliphatic group, an aliphatic oxy group or an acylamino group, more preferably R₄₁ is an aliphatic group, and each of R₄₂, R₄₃, R₄₅ and R₄₆ is independently hydrogen atom, or an aliphatic group.

Preferred examples represented by any of general formulae (1) to (3) will be shown below, but the present invention is not limited thereto.

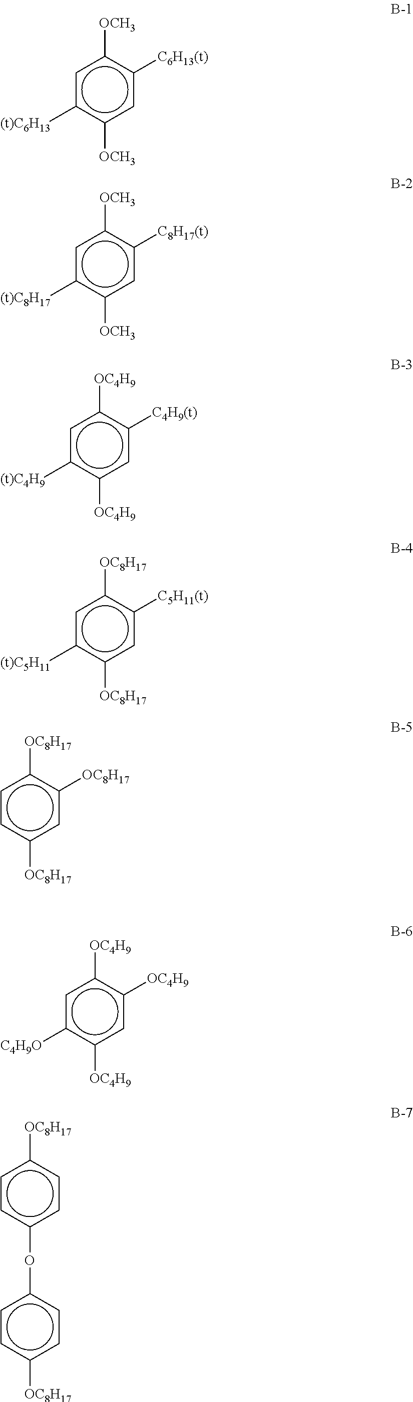

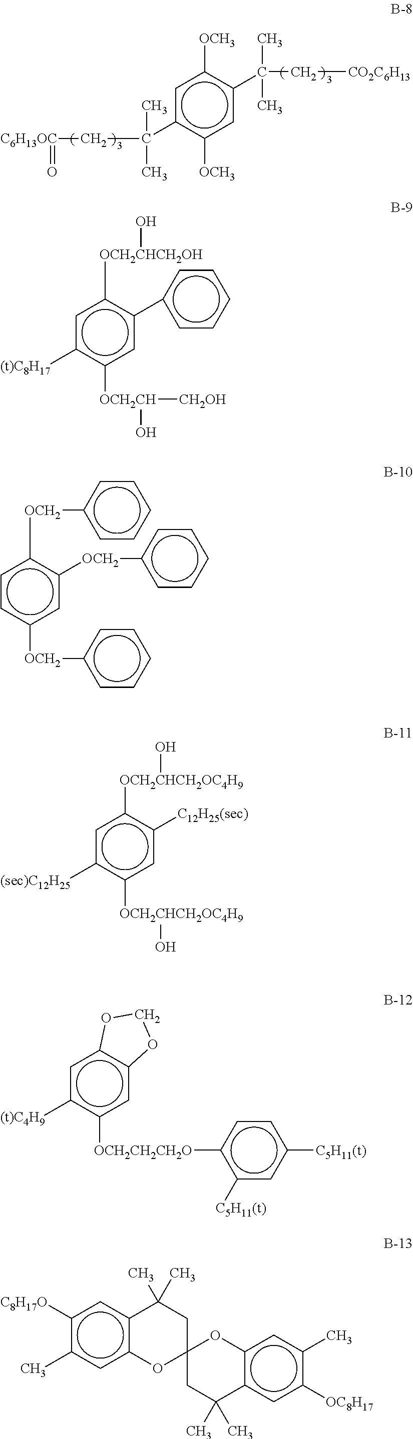

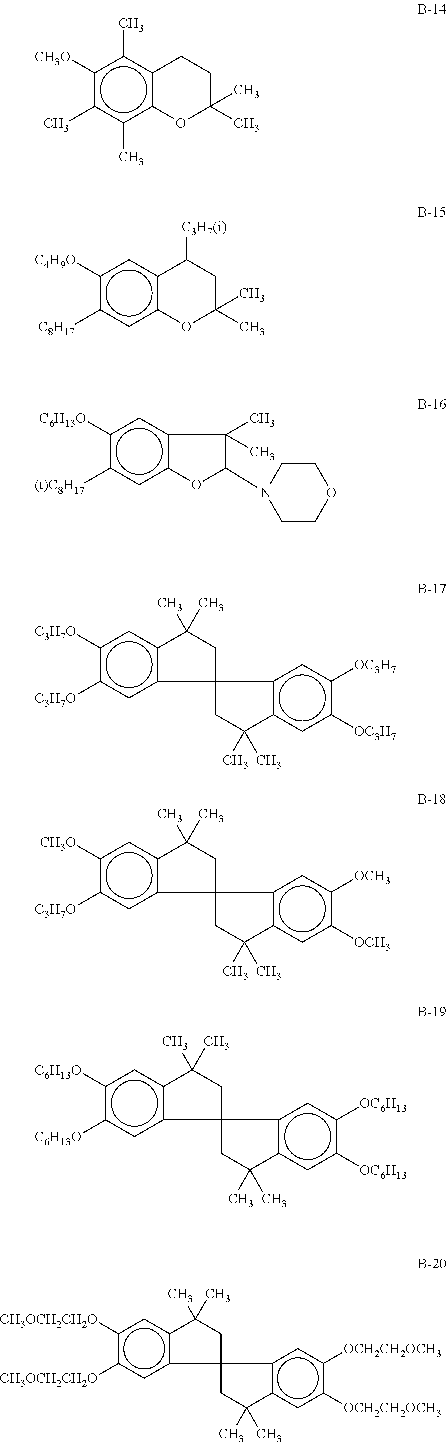

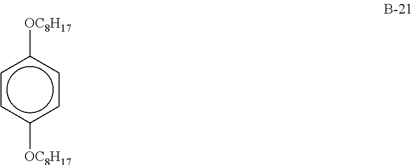

The compound represented by any of general formulae (1) to (3) can be synthesized by the methods described in JP 53-17729 A, JP 53-20327 A, JP 54-145530 A, JP 55-21004 A, and JP 56-159644 A, and by a method conforming to these methods.

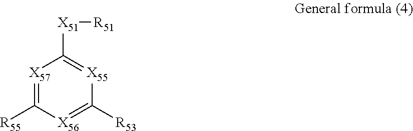

In general formula (4), R₅₁ represents hydrogen atom, an aliphatic group (for example, methyl, i-propyl, s-butyl, dodecyl, methoxyethoxy, allyl, benzyl), an aryl group (for example, phenyl, p-methoxyphenyl), a hetero cyclic group (for example, 2-tetrahydrofuryl, pyranyl), an acyl group (for example, acetyl, pivaloyl, benzoyl, acryloyl), an aliphatic oxycarbonyl group (for example, methoxycarbonyl, hexadecyloxycarbonyl), an aryloxycarbonyl group (for example, phenoxycarbonyl, p-methoxyphenoxycarbonyl), an aliphatic sulfonyl group (for example, methanesulfonyl, butanesulfonyl), an arylsulfonyl group (for example, benzenesulfonyl, p-toluenesulfonyl), a phospholyl group (for example, diethylphospholyl, diphenylphospholyl, diphenoxyphospholyl) or —Si(R₅₈)(R₅₉)(R₆₀). Here, R₅₈, R₅₉, and R₆₀ may be the same or different, and each represents independently an aliphatic group (for example, methyl, ethyl, t-butyl, benzyl, allyl), an aryl group (for example, phenyl), an aliphatic oxy group (for example, methoxy, butoxy) or an aryloxy group (for example, phenoxy).

X₅₁ represents —O— or —N(R₅₇)—. Here, R₅₇ has the same definition as that of R₅₁. X₅₅ represents —N═ or —C(R₅₂)=, X₅₆ represents —N═ or —C(R₅₄)=, X₅₇ represents —N═ or —C(R₅₆)=, respectively. Each of R₅₂, R₅₃, R₅₄, R₅₅, and R₅₆ represents independently hydrogen atom or a substituent, and the preferable substituent is an aliphatic group (for example, methyl, t-butyl, t-hexyl, benzyl), an aryl group (for example, phenyl), an aliphatic oxycarbonyl group (for example, methoxycarbonyl, dodecyloxycarbonyl), an aryloxycarbonyl group (for example, phenoxycarbonyl), an aliphatic sulfonyl group (for example, methanesulfonyl, butanesulfonyl), an aryl sulfonyl group (for example, benzenesulfonyl, p-hydroxybenzenesulfonyl) or —X₅₁—R₅₁.

However, all of R₅₁ to R₅₇ are not hydrogen atoms at the same time, the total number of carbon atoms is 10 or more (preferably 10 to 50), and preferably the total number of carbon atoms is 16 or more (preferably 16 to 40). Furthermore, the compound represented by general formula (4) is not the compound represented by any of general formula (Ph) or general formulae (1) to (3) (namely, excluding the compound represented by any of general formula (Ph) or general formulae (1) to (3)).

The compounds represented by general formula (4) include the compounds represented by general formula (I) of JP 63-50691 B, general formulae (IIIa), (IIIb), (IIIc) of JP 02-37575 B, general formula of JP 02-50457 B, the general formula of JP 05-67220 B, general formula (IX) of JP 05-70809 B, general formula of JP 06-19534 B, general formula (I) of JP 62-227889 A, general formulae (I), (II) of JP 62-244046 A, general formulae (I), (II) of JP 02-66541 A, general formulae (II), (III) of JP 02-139544 A, general formula (I) of JP 02-194062 A, general formulae (B), (C), (D) of JP 02-212836 A, general formula (III) of JP 03-200758 A, general formulae (II), (III) of JP 03-48845 A, general formulae (B), (C), (D) of JP 03-266836 A, general formula (I) of JP 03-969440 A, general formula (I) of JP 04-330440 A, general formula (I) of JP 05-297541 A, the general formula of JP 06-130602 A, general formulae (1), (2), (3) of WO91/11749 A, general formula (I) of DE4008785 A1, general formula (II) of U.S. Pat. No. 4,931,382, general formula (a) of EP 203746 B1, general formula (I) of EP 264730 B1, general formula (III) of JP 62-89962 A, and the like, and can be synthesized according to the methods described in those patent descriptions, or a general method described in SHIN-JIKKENKAGAKU KOZA, Vol. 14 (published by MARUZEN Co., Ltd, 1977, 1978).

Preferred compounds represented by general formula (4) are the compounds represented by any of general formulae (TS-ID) to (TS-IH). The reason is because stability of the compound itself is excellent, and the oxidation resistance is excellent. Among them, the compound represented by general formula (TS-ID) is particularly preferable.

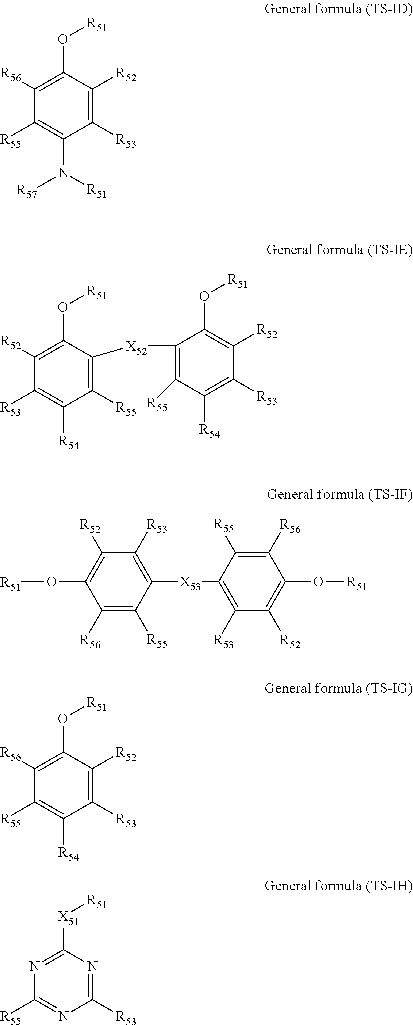

In general formulae (TS-ID) to (TS-IH), R₅₁ to R₅₇ and X₅₁ are the same as defined in general formula (4). Each of X₅₂ and X₅₃ represents independently a divalent connecting group. Examples of the divalent connecting group include an alkylene group, an oxy group, a sulfonyl group, and the like. In the formula, the same symbols may be the same or different.

The compound represented by any of general formulae (TS-ID) to (TS-IG) is not the compounds represented by any of general formula (Ph) and general formulae (1) to (3).

The preferred compounds represented by any of general formulae (TS-ID) to (TS-IH) will be described.

In (TS-ID), preferable is the case where R₅₁ is hydrogen atom, an aliphatic group, an acyl group, an aliphatic oxycarbonyl group, an aryloxycarbonyl group or a phosphoryl group, and each of R₅₂, R₅₃, R₅₅ and R₅₆ is independently hydrogen atom, an aliphatic group, an aliphatic oxy group or an acylamino group, and more preferable is the case where R₅₁ is an aliphatic group, and each of R₅₂, R₅₃, R₅₅ and R₅₆ is independently hydrogen atom or an aliphatic group. In general formulae (TS-IE), (TS-IF), and (TS-IG), preferable is the case where R₅₁ is hydrogen atom, an aliphatic group, an acyl group, an aliphatic oxycarbonyl group, an aryloxycarbonyl group or a phosphoryl group, each of R₅₂, R₅₃, R₅₅ and R₅₆ is independently hydrogen atom, an aliphatic group, an aliphatic oxy group or an acylamino group, R₅₄ is an aliphatic group, a carbamoyl group or an acylamino group, and X₅₂ and X₅₃ are an alkylene group or an oxy group, and more preferable is the case where R₅₁ is hydrogen atom, an aliphatic group, an acyl group or a phosphoryl group, each of R₅₂, R₅₃, R₅₅ and R₅₆ is independently hydrogen atom, an aliphatic group, an aliphatic oxy group or an acylamino group, R₅₄ is an aliphatic group or a carbamoyl group, and X₅₂ and X₅₃ are —CHR₅₈— (R₅₈ is an alkyl group). In general formula (TS-IH), preferable is the case where R₅₁ is an aliphatic group, an aryl group or a heterocyclic group, each of R₅₃, R₅₅ is independently an aliphatic oxy group, an aryloxy group or a heterocyclic oxy group, and more preferable is the case where R₅₁ is an aryl group or a heterocyclic group, each of R₅₃ and R₅₅ is independently an aryloxy group or a heterocyclic oxy group.

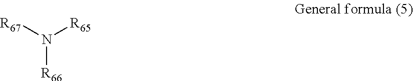

In general formula (5), each of R₆₅ and R₆₆ represents independently hydrogen atom, an aliphatic group (for example, methyl, ethyl, t-butyl, octyl, methoxyethoxy), an aryl group (for example, phenyl, 4-methoxyphenyl), an acyl group (for example, acetyl, pivaloyl, methacryloyl), an aliphatic oxycarbonyl group (for example, methoxycarbonyl, hexadecyloxycarbonyl), an aryloxycarbonyl group (for example, phenoxycarbonyl), a carbamoyl group (for example, dimethylcarbamoyl, phenylcarbamoyl), an aliphatic sulfonyl group (for example, methanesulfonyl, butanesulfonyl) or an aryl sulfonyl group (for example, benzenesulfonyl), R₆₇ represents hydrogen atom, an aliphatic group (for example, methyl, ethyl, t-butyl, octyl, methoxyethoxy), an aliphatic oxy group (for example, methoxy, octyloxy), an aryloxy group (for example, phenoxy, p-methoxyphenoxy), an aliphatic thio group (for example, methylthio, octylthio), an aryl thio group (for example, phenylthio, p-methoxyphenylthio), an acyloxy group (for example, acetoxy, pivaloyloxy), an aliphatic oxycarbonyloxy group (for example, methoxycarbonyloxy, octyloxycarbonyloxy), an aryloxycarbonyloxy group (for example, phenoxycarbonyloxy), a substituted amino group (the substitute may be any of those being capable of substituting, for example, an amino group which is substituted by an aliphatic group, an aryl group, an acyl group, an aliphatic sulfonyl group, an aryl sulfonyl group, and the like), a heterocyclic group (for example, piperidine, thiomorpholine) or hydroxyl group, and if possible, R₆₅ and R₆₆, R₆₆ and R₆₇, R₆₅ and R₆₇ may be bonded to each other to thereby form 5-membered to 7-membered ring (morpholine ring, pyrazolidine ring), but do not form a 2,2,6,6-tetraalkylpiperidine skeleton. However, both of R₆₅, R₆₆ are not hydrogen atoms at the same time, the total number of carbon atoms of the compound represented by general formula (5) is 7 or more (preferably 7 to 50).

The compounds represented by general formula (5) include the compounds represented by general formula (I) of JP 06-97332 B, general formula (I) of JP 06-97334 B, general formula (I) of JP 02-148037 A, general formula (I) of JP 02-150841 A, general formula (I) of JP 02-181145 A, general formula (I) of JP 03-266836 A, general formula (IV) of JP 04-350854 A, general formula (I) of JP 05-61166 A, and the like, and can be synthesized according to the methods described in those patent descriptions, or a general method described in SHIN-JIKKENKAGAKU KOZA, Vol. 14 (published by MARUZEN Co., Ltd, 1977, 1978).

Preferred compounds represented by general formula (5) are the compounds represented by any of general formulae (TS-IIIA) to (TS-IIID), from the viewpoint of stability of the compound itself.

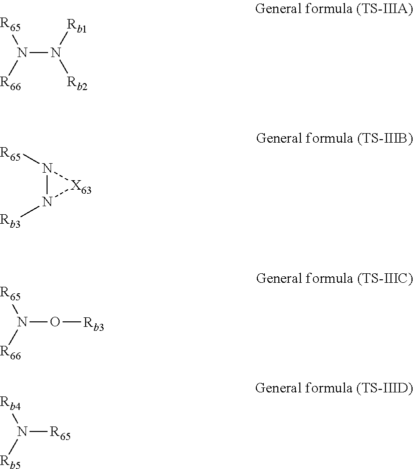

In general formulae (TS-IIIA) to (TS-IIID), R₆₅ to R₆₆ are the same as defined in general formula (5). R_{b1} to R_{b3}, and R_{b5} are the same as defined in R₆₅, R_{b4} is hydrogen atom, an aliphatic group (for example, octyl, dodecyl, 3-phenoxypropyl) or an aryl group (for example, phenyl, 4-dodecyloxyphenyl). X₆₃ represents non-metal atom group which is necessary for forming 5-membered to 7-membered rings (for example, pyrazolidine ring, pyrazoline ring).

The preferred compounds represented by any of general formulae (TS-IIIA) to (TS-IIID) will be explained. In general formula (TS-IIIA), preferable is the case where each of R₆₅ and R_{b1} is independently hydrogen atom, an aliphatic group or an aryl group, each of R₆₆ and R_{b2} is independently an aliphatic group, an aryl group or an acyl group, and more preferable is the case where each of R₆₅ and R_{b1} is independently an aliphatic group, each of R₆₆ and R_{b2} is independently an aliphatic group, an aryl group or an acyl group. In general formula (TS-IIIB), preferable is the case where R₆₅ is hydrogen atom, an aliphatic group, an aryl group, an acyl group or an aliphatic oxycarbonyl group, R_{b3} is an aliphatic group, an aryl group or an acyl group, X₆₃ is a non-metal atom group for forming a 5-membered ring, and more preferable is the case where R₆₅ is hydrogen atom or an aliphatic group, R_{b3} is an aliphatic group or an aryl group, X₆₃ is an atom group for forming pyrazolidine ring. In general formula (TS-IIIC), each of R₆₅ and R₆₆ is independently hydrogen atom, an aliphatic group, an aryl group, an acyl group, an aliphatic oxycarbonyl group or an aryloxycarbonyl group, R_{b3} is hydrogen atom, an aliphatic group or an acyl group, and more preferable is the case where each of R₆₅ and R₆₆ is independently an aliphatic group, an acyl group or an aliphatic oxycarbonyl group, R_{b3} is hydrogen atom, an aliphatic group or an acyl group. In general formula (TS-IIID), preferable is the case where R₆₅ is hydrogen atom, an aliphatic group, an aryl group, an acyl group or a carbamoyl group, R_{b5} is an aliphatic group or an aryl group, R_{b4} is an aliphatic group or an aryl group, and more preferable is the case where R₆₅ is an aliphatic group, an aryl group, an acyl group or a carbamoyl group, R_{b5} is an aliphatic group or an aryl group, R_{b4} is an aliphatic group or an aryl group.

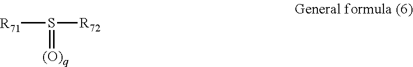

In general formula (6), each of R₇₁ and R₇₂ represents independently an aliphatic group (for example, methyl, methoxycarbonylethyl, dodecyloxycarbonylethyl, benzyl), an aryl group (for example, phenyl, 4-octyloxyphenyl, 2-butoxy-5-(t)octylphenyl) or a heterocyclic group (for example, 2-pyridyl, 2-pyrrimidyl), furthermore, R₇₁ represents hydrogen atom, Li, Na or K, and R₇₁ and R₇₂ may be bonded to each other to thereby form a 5-membered to 7-membered ring (for example, tetrahydrothiophene ring, thiomorpholine ring). q represents 0, 1 or 2. However, the total number of carbon atoms of R₇₁ and R₇₂ is 10 or more (preferably 10 to 60).

The compounds represented by general formula (6) include the compounds represented by general formula (I) of JP 02-44052 B, general formula (T) of JP 03-48242 A, general formula (A) of JP 03-266836 A, general formulae (I), (II), (Ill) of JP 05-323545 A, general formula (I) of JP 06-148837 A, general formula (I) of U.S. Pat. No. 4,933,271, general formula (1) of U.S. Pat. No. 4,770,987, and the like, and can be synthesized in accordance with the methods described in those patent descriptions, or a general method described in SHIN-JIKKENKAGAKU KOZA, Vol. 14 (published by MARUZEN Co., Ltd, 1977, 1978).

In general formula (6), q is preferably 0 or 2, and when q is 0, preferable is the case where each of R₇₁ and R₇₂ is independently an aliphatic group or an aryl group, or the case where R₇₁ and R₇₂ are bonded together to thereby form a 6-membered ring, and when q is 2, preferable is R₇₁ is hydrogen atom, Na, K, an aliphatic group or an aryl group, R₇₂ is an aliphatic group or an aryl group, and more preferable is the case where R₇₁ is hydrogen atom, Na or K, and R₇₂ is an aryl group. The reason is because the function as an antioxidant can be further enhanced.

Furthermore, the combined use of the compound represented by general formulae (4) to (6) and the compound represented by general formulae (1) to (3) is particularly preferable for improving light stability of the quantum dot particles.

Hereinafter, the specific examples of the compounds represented by general formulae (4) to (6) will be shown, but the present invention is not limited thereto.

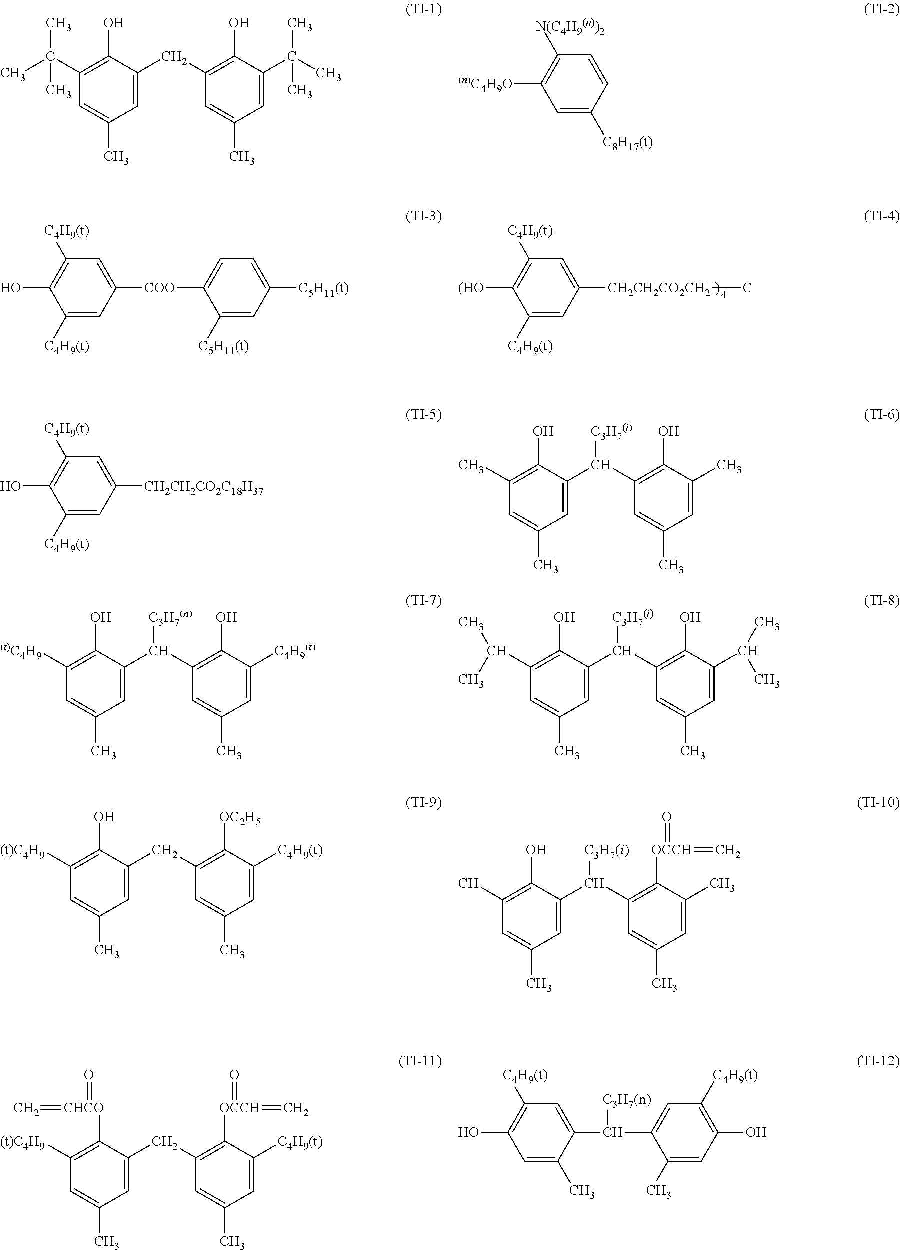

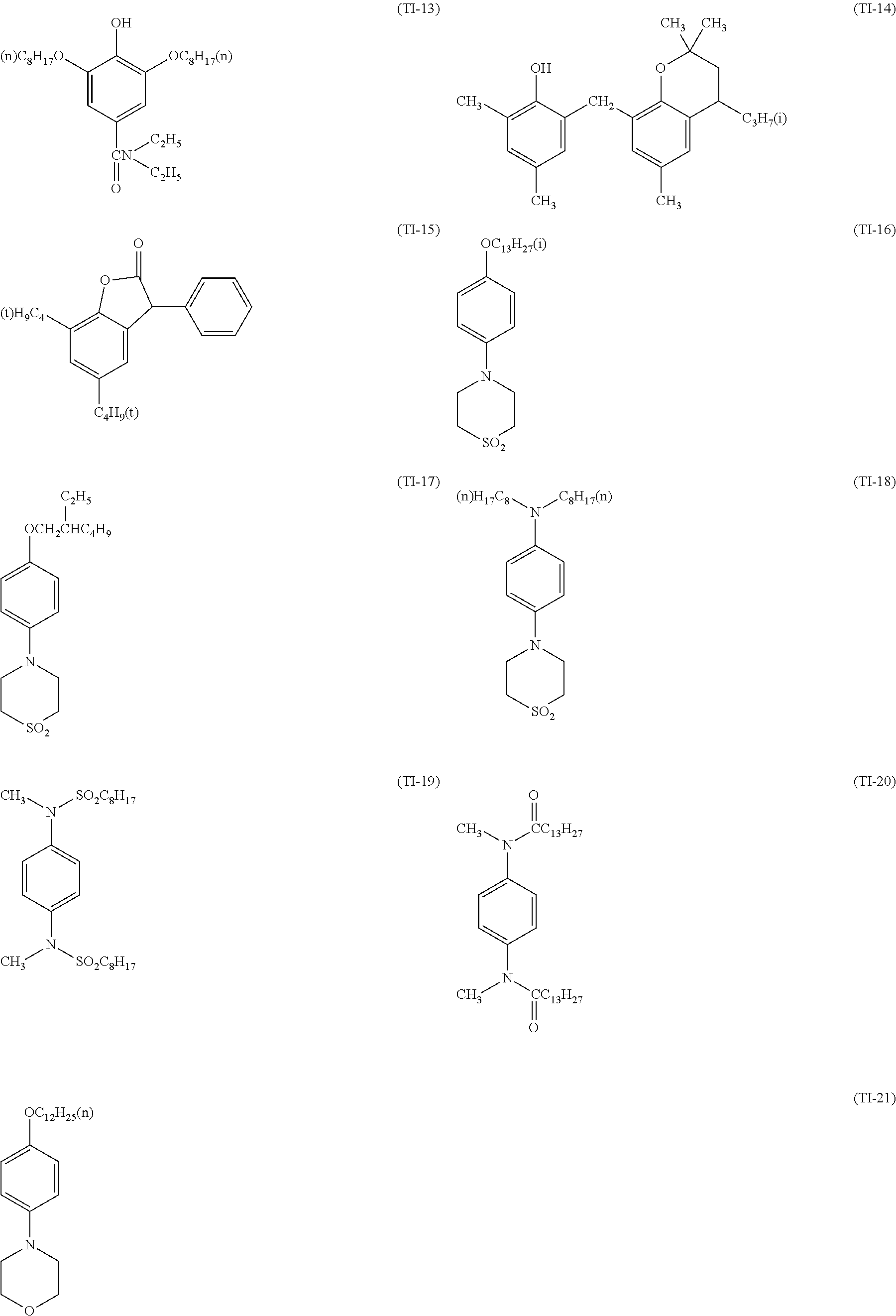

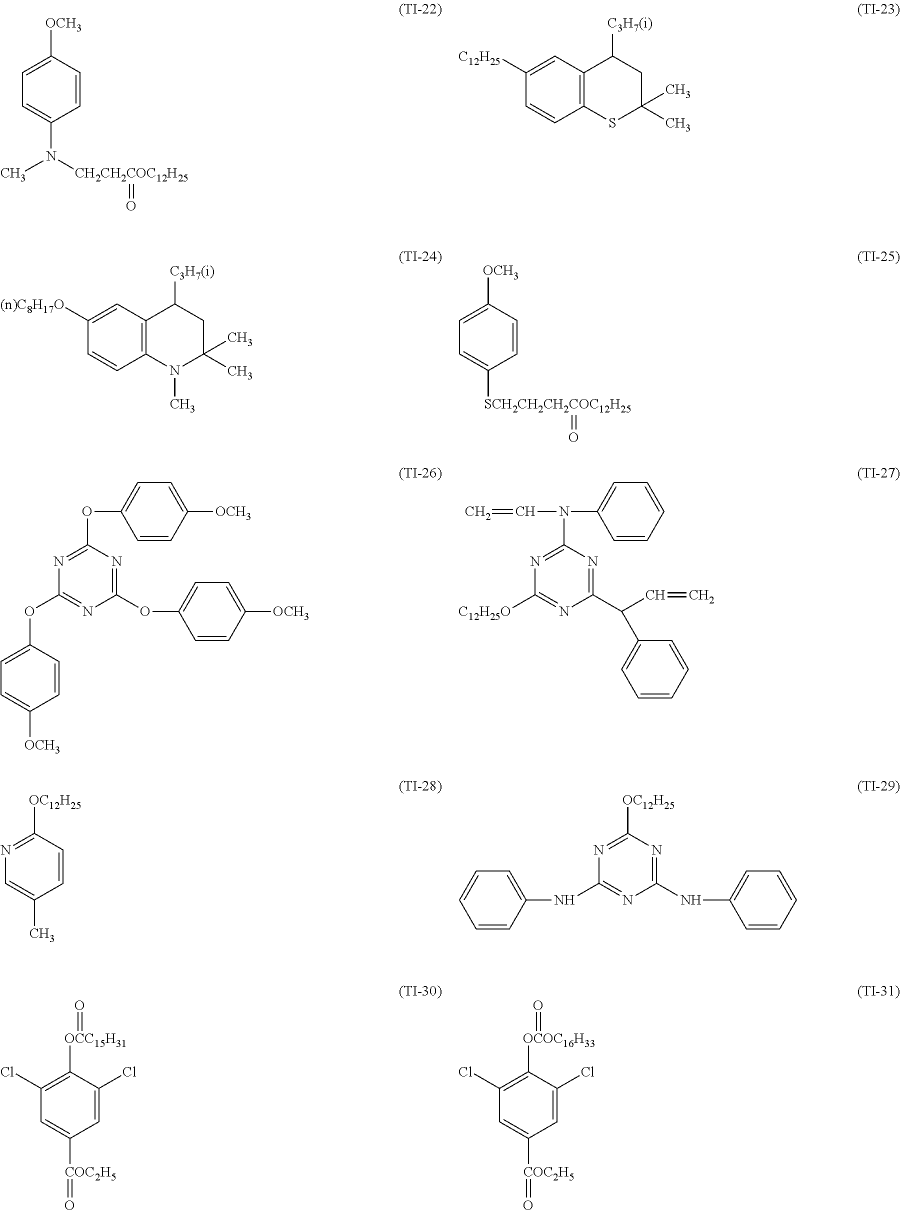

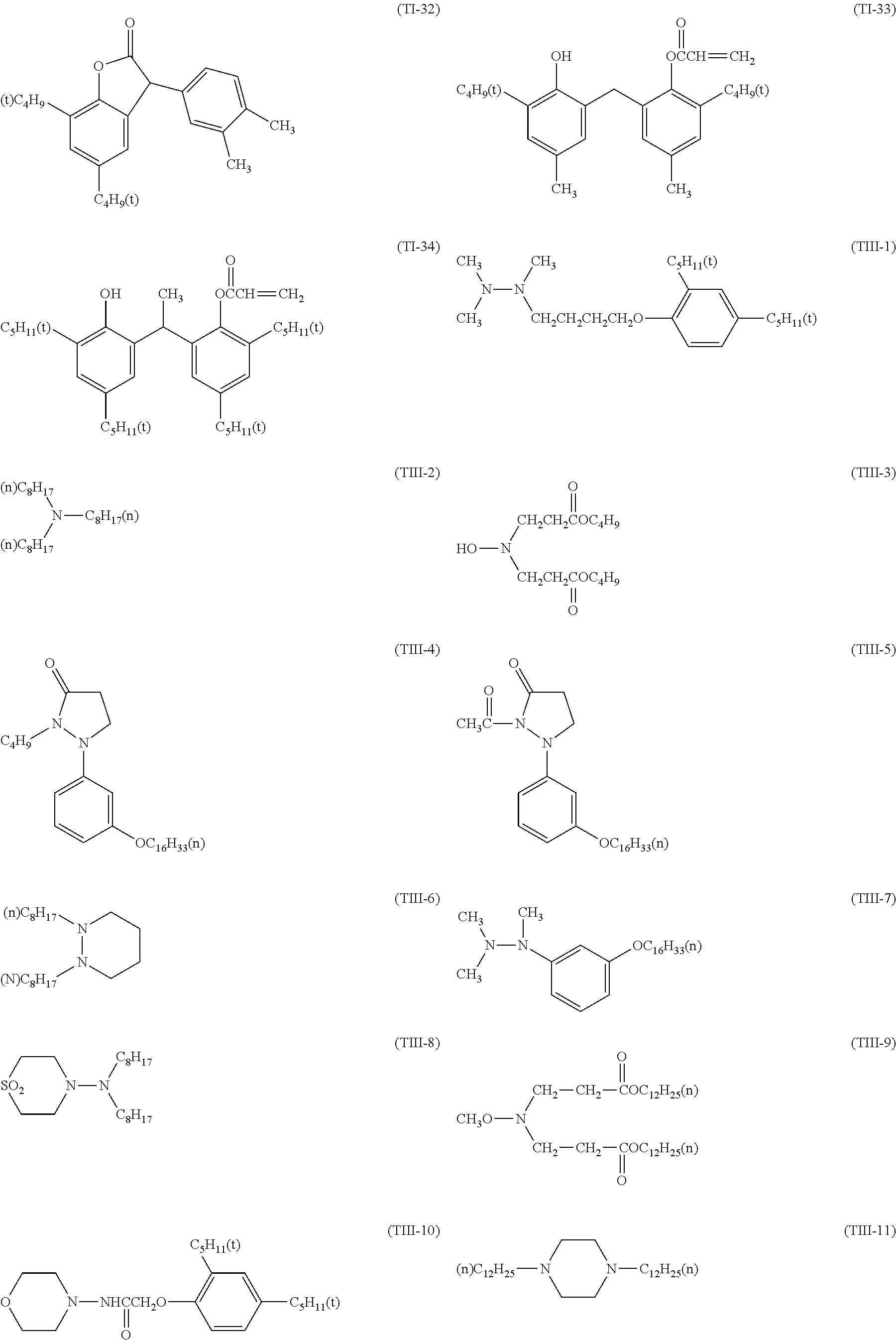

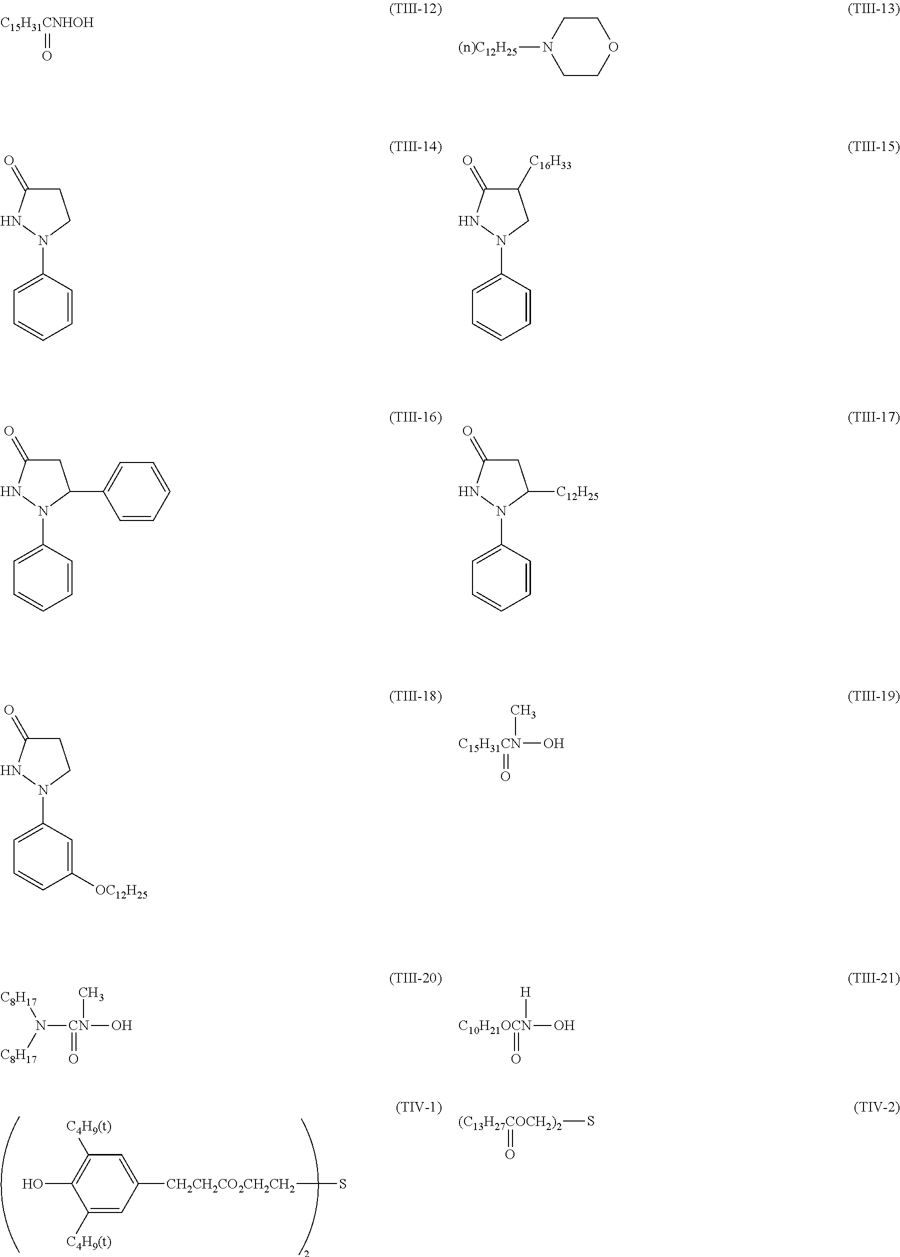

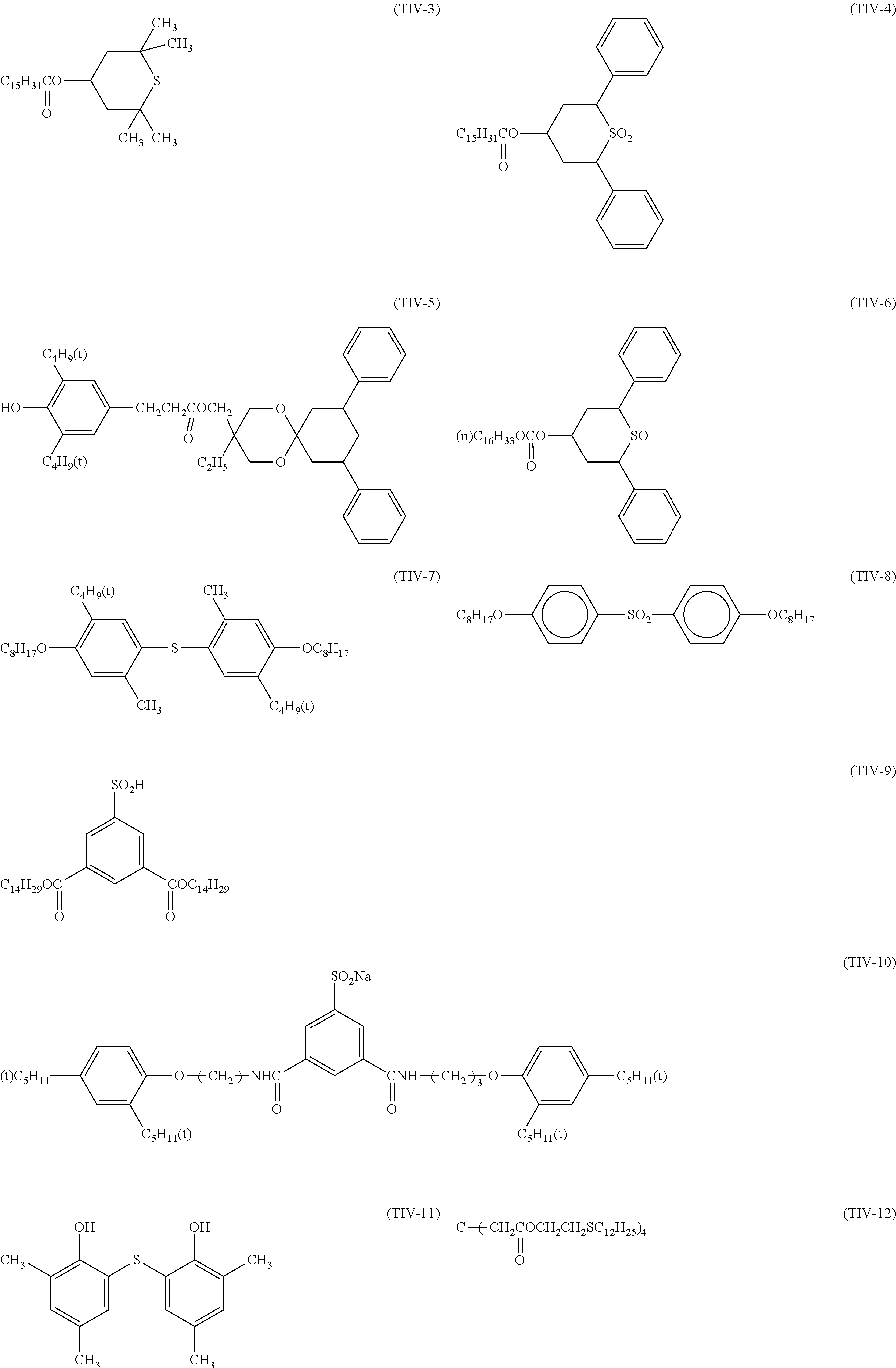

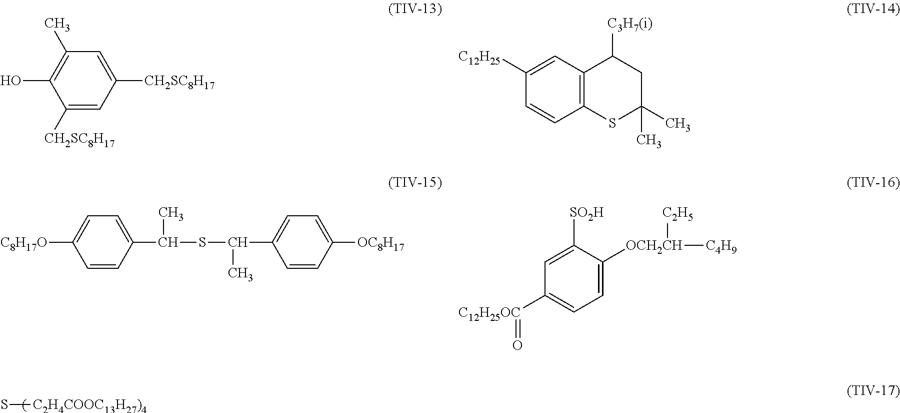

In the quantum dot-containing polymerizable composition, the compound represented by any of general formulae (1) to (6) is, from the viewpoint of obtaining the effect of an antioxidant, preferably 0.1% by mass or more, more preferably 0.5% by mass or more, further preferably 1% by mass or more relative to the total mass of the polymerizable compounds contained in the polymerizable composition. On the other hand, the compound is, from the viewpoint of preventing curing inhibition and coloring, the amount is preferably 20% by mass or less, more preferably 15% by mass or less, further preferably 10% by mass or less.

### (Polymerization Initiator)

The quantum dot-containing polymerizable composition can contain, as a polymerization initiator, a known radical polymerization initiator. With respect to the polymerization initiator, for example, the descriptions of Paragraph 0037 of JP 2013-043382 A can be referred to. An amount of the polymerization initiator is preferably 0.1 mole % or more relative to the total amount of the polymerizable compounds contained in the polymerizable composition, more preferably 0.5 to 5 mole %.

In addition, the amount of the polymerization initiator contained in the quantum dot-containing polymerizable composition is preferably 0.1 mass % or more and more preferably 0.2 to 3 mass % with respect to the total amount of the polymerizable compound contained in the polymerizable composition.

### (Silane Coupling Agent)

The quantum dot-containing polymerizable composition may contain a silane coupling agent. A wavelength conversion layer formed from a polymerizable composition containing a silane coupling agent can exert a further improved light resistance, because the adhesion to an adjacent layer is enhanced. This is mainly because the silane coupling agent contained in wavelength conversion layer forms a covalent bond with the surface or the constituent of the adjacent layer by hydrolysis or a condensation reaction. It is preferable to provide the inorganic layer described below as the adjacent layer. In addition, when the silane coupling agent has a reactive functional group such as a radical polymerizable group, formation of cross linking structure with a monomer component constituting the wavelength conversion layer also contributes the enhancement of the adhesion to the layer adjacent to the wavelength conversion layer. In the present description, a silane coupling agent contained in wavelength conversion layer is used in a meaning that a silane coupling agent of a form after the above reaction is included.

Any known one can be used as a silane coupling agent without any limitation. From the viewpoint of adhesion, preferred silane coupling agent include a silane coupling agent represented by general formula (1) described in JP 2013-43382 A. For details, Paragraphs 0011 to 0016 of JP 2013-43382 can be referred to. The use amount of the additives such as the silane coupling agent is not particularly limited, and can be optionally set.

### (Solvent)

The quantum dot-containing polymerizable composition may contain a solvent as necessary. In this case, the type and the amount of the solvent to be used are not particularly limited. For example, an organic solvent can be used alone or by mixing two or more kinds thereof.

### <Method for Forming Wavelength Conversion Layer>

The wavelength conversion layer can be formed by applying, on a suitable base material, the quantum dot-containing polymerizable composition and then by polymerizing and curing the coating film by being subjected to polymerization treatment such as light irradiation or heating. Examples of the application method include known application methods such as curtain coating method, dip coating method, spin coating method, print coating method, spray coating method, slot coating method, roll coating method, slide coating method, blade coating method, gravure coating method, and wire bar method. The curing conditions can be appropriately set depending on the type of the polymerizable compound and the composition of the polymerizable composition. In addition, when the quantum dot-containing polymerizable composition is a composition containing a solvent, a drying treatment for removing the solvent may be carried out before a polymerization treatment.

The polymerization treatment of the quantum dot-containing polymerizable composition can be carried out in the manner that the composition is sandwiched between two base materials. One embodiment of the preparation steps of the wavelength conversion member including the polymerization treatment will be described below by referring to drawings. However, the present invention is not limited to the following embodiment.

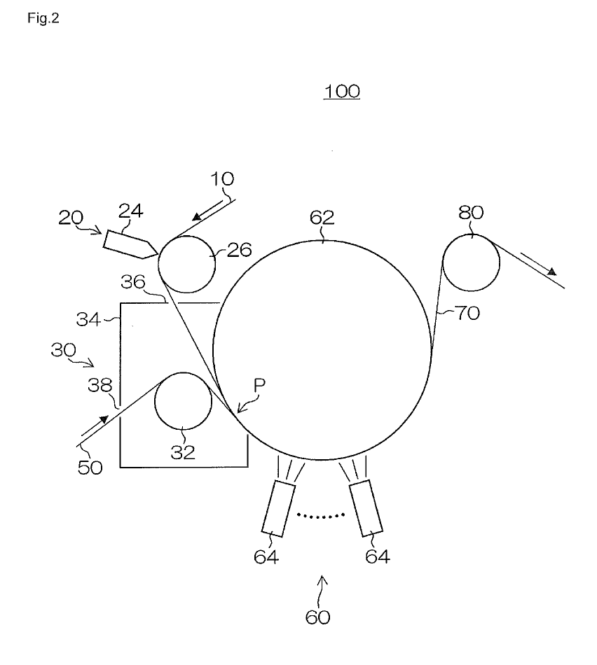

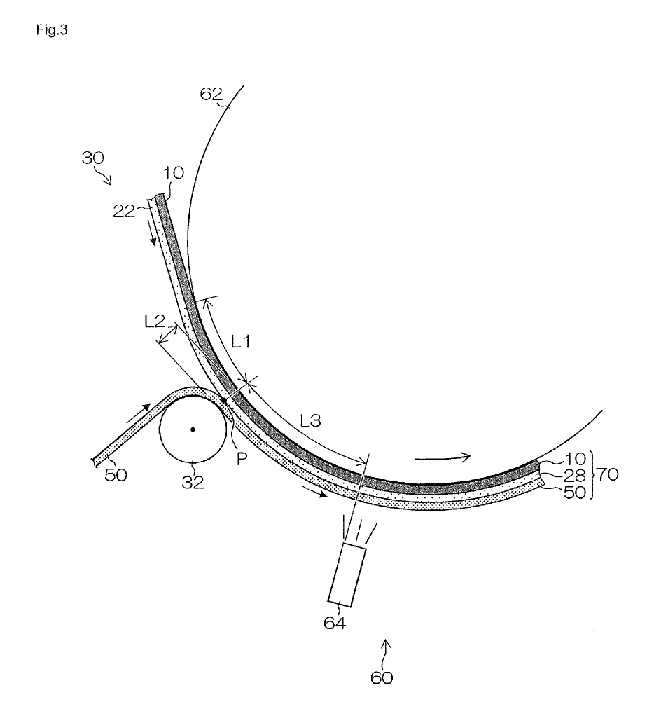

FIG. 2 shows a schematic configuration diagram of one example of a manufacturing apparatus 100 of the wavelength conversion member, and FIG. 3 shows a partially enlarged view of the manufacturing apparatus shown in FIG. 2. The preparation process of the wavelength conversion member by using the manufacturing apparatus 100 shown in FIGS. 2, 3 includes at least:

a step of forming a coating film by applying a quantum dot-containing polymerizable composition on a surface of a first base material (hereinafter, also referred to as “first film”) which is continuously conveyed,
a step of laminating (overlapping) on the coating film a second base material (hereinafter, also referred to as “second film”) which is continuously conveyed to sandwich the coating film by the first film and the second film,
a step of taking up any one of the first film and the second film on a backup roller while maintaining the coating film sandwiched by the first film and the second film, and polymerizing and curing the coating film by irradiation of light while conveying the coating film continuously, to form a wavelength conversion layer (cured layer).
By using a barrier film having a barrier property against the oxygen and water as one of the first base material and the second base material, a wavelength conversion member which is protected on one side by the barrier film can be obtained. In addition, when using the barrier film as each of a first base material and the second base material, a wavelength conversion member where both sides of the wavelength conversion layer are protected by the barrier films can be obtained.

More specifically, first, a first film 10 is continuously conveyed from a feeding machine (not shown) to an application portion 20. From the feeding machine, the first film 10 is fed out, for example, at a conveyance speed of 1 to 50 m/min. However, the conveyance speed is not limited to the above speed. When being fed out, for example, a tension of 20 to 150 N/m, preferably 30 to 100 N/m, is applied to the first film 10.

In the application portion 20, the quantum dot-containing polymerizable composition (hereinafter also referred to as “application liquid”) is applied to the surface of the first film 10 to be continuously conveyed and thus a coating film 22 is formed (see FIG. 2). In the application portion 20, for example, a die coater 24 and a backup roller 26 that is arranged opposite to the die coater 24 are provided. The surface of the first film 10 opposite to the surface on which the coating film 22 is formed is wound on the backup roller 26, and the application liquid is applied from a discharge port of the die coater 24 to the surface of the first film 10 that is to be continuously conveyed and thus the coating film 22 is formed. Here, the coating film 22 is a quantum dot-containing polymerizable composition before polymerization treatment, which is applied on the first film 10,

In the present embodiment, the die coater 24 in which an extrusion coating method is used as an application apparatus is illustrated, but the present invention is not limited thereto. For example, application apparatuses in which various method such as curtain coating method, extrusion coating method, rod coating method or role coating method is used can be used.

The first film 10 which passes through the application portion 20 and on which the coating film 22 is formed is continuously conveyed to a laminating portion 30. In the laminating portion 30, a second film 50 which is continuously conveyed is laminated on the coating film 22 and thus the coating film 22 is sandwiched by the first film 10 and the second film 50.

In the laminating portion 30, a laminate roller 32 and a heating chamber 34 surrounding the laminate roller 32 are provided. The heating chamber 34 is provided with an opening 36 for the first film 10 to pass through and an opening 38 for the second film 50 to pass through.

A backup roller 62 is arranged at the position facing the laminate roller 32. The first film 10 on which the coating film 22 is formed is wound on the backup roller 62 at the surface opposite to the surface on which the coating film 22 is formed, and is continuously conveyed to a lamination position P. The lamination position P means a position where contact of the second film 50 with the coating film 22 starts. The first film 10 is preferably wound on the backup roller 62 before reaching the lamination position P. This is because, even if wrinkles are generated on the first film 10, the wrinkles can be corrected and removed by the backup roller 62 before the first film 10 reaches the lamination position P. Accordingly, a distance L1 from the point (contact position) where the first film 10 is wound on the backup roller 62 to the lamination position P is preferably long, for example, preferably 30 mm or more, and the upper limit is usually determined by a diameter of the backup roller 62 and a passing line.

According to the present embodiment, the lamination of the second film 50 is performed by the backup roller 62 used in a polymerization treatment portion 60 and the laminate roller 32. Namely, the backup roller 62 used in the polymerization treatment portion 60 doubles as a roller in the laminating portion 30. However, the present invention is not limited to the above embodiment, and, a roller for lamination, which is not double as the backup roller 62, can be provided in the laminating portion 30 separately from the backup roller 62.

It is possible to reduce the number of rollers by using, in the laminating portion 30, the backup roller 62 used in the polymerization treatment portion 60. In addition, the backup roller 62 can also be used as a heat roller to the first film 10.

The second film 50 fed from the feeding machine which is not shown is wound on the laminate roller 32, and is continuously conveyed between the laminate roller 32 and the backup roller 62. The second film 50 is laminated on the coating film 22 formed on the first film 10 at the lamination position P. Thereby, the coating film 22 is sandwiched by the first film 10 and the second film 50. The term, laminate means stacking by overlapping the second film 50 on the coating film 22.

A distance L2 between the laminate roller 32 and the backup roller 62 is preferably a value of total thickness of the first film 10, the wavelength conversion layer (cured layer) 28 prepared by polymerizing and curing the coating film 22, and the second film 50, or more. L2 is preferably a length of total thickness of the first film 10, the coating film 22 and the second film 50 plus 5 mm, or shorter. When the distance L2 is the total thickness plus 5 mm or shorter, penetration of foam between the second film 50 and the coating film 22 can be prevented. The distance L2 between the laminate roller 32 and the backup roller 62 means the shortest distance from the outer peripheral surface of the laminate roller 32 and the outer peripheral surface of the backup roller 62.

A rotation accuracy of the laminate roller 32 and the backup roller 62 is 0.05 mm or lessand, preferably 0.01 mm or less in a radian run-out. The smaller the radian run-out, the smaller the thickness distribution of the coating film 22 can be.

In order to inhibit the thermal deformation after sandwiching the coating film 22 by the first film 10 and the second film 50, a difference of a temperature of the backup roller 62 and a temperature of the first film 10 and a difference of a temperature of the backup roller 62 and a temperature of the second film 50 in the polymerization treatment portion 60 is preferably 30° C. or less, more preferably 15° C. or less, most preferably zero.

In order to make the difference from the temperature of the backup roller 62 smaller, when the heating chamber 34 is provided, it is preferable to heat the first film 10 and the second film 50 in the heating chamber 34. For example, a heated air can be supplied to the heating chamber 34 from a heated air generation device which is not shown to heat the first film 10 and the second film 50.

The first film 10 may be heated by the backup roller 62 by winding the first film 10 on the temperature-controlled backup roller 62.

On the other hand, with respect to the second film 50, by using the laminate roller 32 as a heating roller, the second film 50 can be heated by the laminate roller 32.

The heating chamber 34 and the heating roller are not essential, and may be provided as necessary.

Next, in a state where the coating film 22 is sandwiched by the first film 10 and the second film 50, the coating film 22 is continuously conveyed to the polymerization treatment portion 60. In the embodiment shown by the drawings, the polymerization treatment in the polymerization treatment portion 60 is performed by light irradiation, and in case where the polymerizable compound contained in the quantum dot-containing polymerizable composition is a compound which is polymerized by heating, the polymerization treatment can be performed by heating such as blowing of warm air.

The backup roller 62 and a light irradiation device 64 at the position facing the backup roller 62 are provided. The first film 10 and the second film 50 which sandwich the coating film 22 are continuously conveyed between the backup roller 62 and the light irradiation device 64. The light irradiated from the light irradiation device may be determined depending on the type of the photopolymerizable compound contained in the quantum dot-containing polymerizable composition, and one example includes an ultraviolet ray. Here, the ultraviolet ray means light having a wavelength of 280 to 400 nm. Examples of a usable light source generating the ultraviolet ray include a low-pressure mercury lamp, a middle-pressure mercury lamp, a high-pressure mercury lamp, a super high-pressure mercury lamp, a carbon arc lamp, a metal halide lamp, a xenon lamp, and the like. Irradiation energy may be set within the range that can progress the polymerization and curing of the coating film, and for example, as one example, an ultraviolet ray at irradiation energy of 100 to 10000 mJ/cm² can be irradiated to the coating film 22.

In the polymerization treatment portion 60, the first film 10 is wound on the backup roller 62 in a state where the coating film 22 is sandwiched by the first film 10 and the second film 50, and while continuously conveyed, the coating film 22 can be cured by light irradiation from the light irradiation device 64, to form the wavelength conversion layer (cured layer) 28.

In the present embodiment, the side of the first film 10 is wound on the backup roller 62 and continuously conveyed, but it is also possible that the second film 50 is wound on the backup roller 62 and continuously conveyed.

“Being wound on the backup roller 62” means a state where one of the first film 10 and the second film 50 is in contact with the surface of the backup roller 62 at a certain wrap angle. Accordingly, during continuous conveyance, the first film 10 and the second film 50 moves in synchronization with the rotation of the backup roller 62. The winding on the backup roller 62 may be kept at least during the ultraviolet ray irradiation.

The backup roller 62 is provided with a column-shaped main body and axes of rotation arranged at the both edges of the main body. The main body of the backup roller 62 has a diameter φ of, for example, 200 to 1000 mm. The diameter φ of the backup roller 62 is not limited. In consideration of the curl deformation, cost for equipment, and rotation accuracy, the diameter is preferably φ 300 to 500 mm. The temperature of the backup roller 62 can be regulated by attaching a temperature regulator to the main body of the backup roller 62.

The temperature of the backup roller 62 can be determined in consideration of the heat generation at the time of light irradiation, the curing efficiency of the coating film 22, the generation of the wrinkle deformation of the first film 10 and the second film 50 on the backup roller 62. The temperature of the backup roller 62 is preferably set within the range of 10 to 95° C., more preferably 15 to 85° C. Here, the temperature relating to the roller means a surface temperature of the roller.

A distance L3 between the lamination position P and the light irradiation device 64 can be, for example, 30 mm or more.

As a result of light irradiation, the coating film 22 serves as the cured layer 28 to thereby produce a wavelength conversion member 70 including the first film 10, the cured layer 28 and the second film 50. The wavelength conversion member 70 is peeled off from the backup roller 62 by a peeling roller 80. The wavelength conversion member 70 is continuously conveyed to a take-up machine which is not shown in the drawing, and then the wavelength conversion member 70 is wound in a form of roll by the take-up machine.

One aspect of the manufacturing process of the wavelength conversion member has been explained above, but the present invention is not limited to the above aspect. For example, a wavelength conversion layer (cured layer) may be produced by applying the quantum dot-containing polymerizable composition on the base material and by performing the polymerization treatment after dry-treatment as necessary, without laminating the further base material thereon. One or more other layers can also be laminated on the produced wavelength conversion layer, by a known method.

The total thickness of the wavelength conversion layer is preferably within the range of 1 to 500 μm (micrometers), more preferably within the range of 100 to 400 μm (micrometers). The wavelength conversion layer may be two or more laminated structure, and may contain, in one layer, two or more types of quantum dot having different light emission properties. When the wavelength conversion layer is a laminated body composed of two or more layers, a thickness of one layer is preferably within the range of 1 to 300 μm (micrometers), more preferably within the range of 10 to 250 μm (micrometers), and further preferably within the range of 30 to 150 μm (micrometers).

### <Other Layers, Base Material>

The above-described wavelength conversion member may be a structure consisting of the wavelength conversion layer or may be a structure having a base material to be described later in addition to the wavelength conversion layer. Alternatively, at least one surface of the wavelength conversion layer can have at least one layer selected from the group consisting of an inorganic layer and an organic layer. Such an inorganic layer and an organic layer can include an inorganic layer and an organic layer constituting a barrier film mentioned below. From the viewpoint of maintaining light emitting efficiency, each main surface of the wavelength conversion layer preferably includes at least one layer selected from the group consisting of an inorganic layer and an organic layer. This is because the intrusion of oxygen from the main surfaces to the wavelength conversion layer can be prevented by the above layers. In addition, according to one aspect, the inorganic layer and the organic layer are preferably included as an adjacent layer which is directly in contact with a main surface of the wavelength conversion layer. Additionally, according to another aspect, a main surface of the wavelength conversion layer may be pasted to other layer via a known adhesive layer. According to one aspect, the whole surface of the wavelength conversion layer may be covered by a coating (namely, be sealed), but from the viewpoint of productivity, instead of covering the whole surface with a coating, it is preferable that the both main surfaces are protected by the other layer, preferably, the barrier film described below and the both sides are in a state of being exposed to atmosphere. Even in this state, the deterioration of a quantum dot by oxygen can be suppressed, because the wavelength conversion layer has low oxygen permeability.

### (Base Material)

The wavelength conversion member may have a base material for enhancement of strength, ease of film formation, and the like. The base material may be directly in contact with the wavelength conversion layer. The wavelength conversion member may include one or two or more of the base materials, and the wavelength conversion member may have a structure in which the base material, the wavelength conversion member and the base material are laminated in this order. When the wavelength conversion member has two or more base materials, the base materials may be the same or different. The base material is preferably transparent at a visible light. Here, being transparent at the visible light means that a light transmittance in a visible light region is 80% or more, preferably 85% or more. The light transmittance used as an index of transparency can be calculated in accordance with the method described in JIS-K 7105, namely, by measuring a whole light transmittance and scattered luminous energy through the use of an integrated sphere-type light transmittance measuring device, and by subtracting a diffusion transmittance from the whole light transmittance.

The thickness of the base material is preferably within the range of 10 to 500 μm (micrometers), more preferably within the range of 20 to 400 μm (micrometers), particularly preferably within the range of 30 to 300 μm (micrometers), from the viewpoint of gas barrier properties and impact resistance.

The base material may be used as either or each of the above-described first film and the second film.

The base material may be the barrier film. The barrier film is a film having a gas barrier function of blocking oxygen molecules. The barrier film may also preferably have a function of blocking moisture.

The barrier film may usually include at least an inorganic layer, and may be a film containing a supporting film and the inorganic layer. As to the supporting film, for example, Paragraphs 0046 to 0052 of JP2007-290369 A, Paragraphs 0040 to 0055 of JP2005-096108 A can be referred to. The barrier film may be a film which includes a barrier laminate having at least one inorganic layer and at least one organic layer, on the supporting film. Examples are a laminated structure of supporting film/organic layer/inorganic layer, a laminated structure of supporting film/inorganic layer/organic layer, supporting film/organic layer/inorganic layer/organic layer (here, the two organic layers may be the same or different in terms of either or both of thickness and composition), and the like. Since the barrier property can be further increased by laminating a plurality of layers in this way, but the light transmittance of the wavelength conversion member is tend to be decreased along with the increase in the number of laminated layers, it is desirable that the number of the laminated layers is increased within the range in which good light transmittance can be maintained. Specifically, the barrier film preferably has an oxygen permeability of 1 cm³/(m²·day·atm) or less. Here, the above-described oxygen permeability is a value measured by using an oxygen gas permeability measuring device (OX-TRAN 2/20 Trade name: manufactured by MOCON) under the conditions of a measurement temperature 23° C. and a relative humidity 90%. The barrier film preferably has a whole light transmittance over a visible light region of 80% or more. The visible light region means a region with a wavelength of 380 to 780 nm, and the whole light transmittance shows a mean value of the light transmittances over the visible light region.

The oxygen permeability of the barrier film is more preferably 0.1 cm³/(m²·day·atm) or less, further preferably 0.01 cm³/(m²·day·atm) or less. The whole light transmittance in the visible light region is more preferably 90% or more. The lower the oxygen permeability is, the more preferable, and the higher the whole light transmittance in the visible light region is, the more preferable.

### —Inorganic Layer—

The “inorganic layer” is a layer containing an inorganic material as a main component, and preferably is a layer formed only of an inorganic material. In contrast to this, the organic layer is a layer containing an organic material, and is a layer which contains an organic material in an amount of preferably 50% by mass or more, further preferably 80% by mass or more, and particularly preferably 90% by mass or more.

The inorganic material constituting the inorganic layer is not particularly limited, and, for example, various inorganic compounds such as a metal, or an inorganic oxide, an inorganic nitride and an inorganic oxynitride can be used. Silicon, aluminum, magnesium, titanium, tin, indium and cerium are preferable as the element constituting the inorganic material, and one or two or more kinds thereof may be contained. Specific examples of the inorganic compound include silicon oxide, silicon oxynitride, aluminum oxide, magnesium oxide, titanium oxide, tin oxide, indium oxide alloy, silicon nitride, aluminum nitride, titanium nitride. In addition, a metal film such as aluminum film, silver film, tin film, chromium film, nickel film, titanium film may be provided as the inorganic layer.

Among the above-described materials, silicon nitride, silicon oxide, or silicon oxide nitride is particularly preferable. The reason is that since the inorganic layer formed of these materials has good adhesiveness to an organic layer, it is possible to further enhance the barrier property.

A method for forming the inorganic layer is not particularly limited, and various film forming methods that can accumulate a film forming material on a target surface for deposition by evaporating or scattering the material can be used, for example.

Examples of the method for forming the inorganic layer include a physical vapor deposition method such as a vacuum deposition method in which an inorganic material such as an inorganic oxide, an inorganic nitride, an inorganic oxynitride or metal is deposited by heating; an oxidation reaction deposition method in which an inorganic material is used as a raw material, and is oxidized by introducing an oxygen gas to thereby be deposited; a spattering method in which an inorganic material is used as a target material and is subjected to spattering by introducing an argon gas, an oxygen gas to thereby be deposited; or an ion-plating method in which an inorganic material is heated using a plasma beam generated by a plasma gun to thereby be deposited, and a plasma chemical vapor deposition method using an organic silicon compound as a raw material, and the like, in a film-forming of a deposition film of silicon oxide. The deposition may be carried out on a surface of a substrate such as a supporting film, a wavelength conversion layer or an organic layer.

The silicon oxide film is preferably formed by a low temperature plasma chemical vapor deposition method using an organic silicon compound as a raw material. Specific examples of the organic silicon compound can include, specifically, 1,1,3,3-tetramethyldisiloxane, hexamethydisiloxane, vinyltrimethylsilane, hexamethyldisilane, methylsilane, dimethylsilane, trimethylsilane, diethylesilane, propylsilane, phenylsilane, vinyltriethoxysilane, tetramethoxysilane, phenyltriethoxysilane, methyltriethoxysilane, octamethylcyclotetrasiloxane, and the like. In addition, among the above organic silicon compounds, it is preferable to use tetramethoxyxilane (TMOS) or hexamethyldisiloxane (HMDSO). This is because these are excellent in handling and in properties of deposition film.

The thickness of the inorganic layer is, for example, 1 nm to 500 nm, preferably 5 nm to 300 nm, and more preferably within the range of 10 nm to 150 nm. This is because, when the thickness of the inorganic layer is within the above-described range, reflection at the inorganic layer can be inhibited while achieving good barrier property, and thus a wavelength conversion member having a higher light transmittance can be provided.

In the wavelength conversion member, according to one aspect, at least one of the main surfaces of the wavelength conversion layer is preferably in direct contact with the inorganic layer. Each of the main surfaces of the wavelength conversion layer is also preferably in direct contact with the inorganic layer. In addition, according to one aspect, at least one of the main surfaces of the wavelength conversion layer is preferably in direct contact with the organic layer. Each of the main surfaces of the wavelength conversion layer is also preferably in direct contact with the organic layer. Here, the expression “main surface” means a surface (front surface, back surface) of the wavelength conversion layer which is arranged on the viewing side or the backlight side at the time of using the wavelength conversion member. The same also applies to the main surface of the other layer or member. The inorganic layer and the organic layer, two inorganic layers, or two organic layers may be stuck by using a known adhesive layer. From the viewpoint of enhancement of the light transmittance, the number of the adhesive layers is preferably small, and more preferably, no adhesive layer exists. According to one aspect, the inorganic layer is preferably in direct contact with the organic layer.

### —Organic Layer—

With respect to the organic layer, Paragraphs 0020 to 0042 of JP2007-290369 A, Paragraphs 0074 to 0105 of JP2005-096108 A can be referred to. Note that, according to one aspect, the organic layer preferably contains a cardo polymer. This is because adhesion property to the layer adjacent to the organic layer, especially adhesion property to the inorganic layer becomes good, and thus more excellent gas barrier property can be achieved. Details of the cardo polymer can be referred to Paragraphs 0085 to 0095 of JP2005-096108 A. The thickness of the organic layer is preferably within the range of 0.05 μm to 10 μm, particularly preferably within the range of 0.5 μm to 10 μm. When the organic layer is formed by a wet coating method, the thickness of the organic layer is preferably within the range of 0.5 μm to 10 μm, particularly preferably within the range of 1 μm to 5 μm. When the organic layer is formed by a dry coating method, the thickness is preferably within the range of 0.05 μm to 5 μm, particularly preferably within the range of 0.05 μm to 1 μm. This is because, when the thickness of the organic layer formed by the wet coating method or the dry coating method is within the above range, the adhesion property to the inorganic layer can be made better.

Note that, in the present invention and the description, a polymer refers to a polymer obtained by polymerizing the same or different two or more compounds through polymerization reaction, and the expression “polymer” is used in a meaning including an oligomer, and the molecular weight is not particularly limited. In addition, the polymer may be a polymer having a polymerizable group and can be further polymerized by being subjected to a polymerization treatment such as heating or light irradiation, depending on kinds of polymerizable group. Note that the above-described polymerizable compound such as the alicyclic epoxy compound, the mono-functional (meth)acrylate compound and the poly-functional (meth)acrylate compound may correspond to the polymer having the above meaning.

In addition, the organic layer can be a cured layer formed by curing the polymerizable composition containing a (meth)acrylate polymer. The (meth)acrylate polymer is a polymer containing one or more (meth)acryloyl groups in one molecule. Examples of the (meth)acrylate polymer used for forming the organic layer can include is a (meth) acrylate polymer containing one or more urethane bonds in one molecule. Hereinafter, the (meth)acrylate polymer containing one or more urethane bonds in one molecule will be described as the urethane bond-containing (meth)acrylate polymer. When the barrier layer includes two or more organic layers, a cured layer formed by curing a polymerizable composition containing the urethane bond-containing (meth)acrylate polymer and other organic layer may be included. According to one aspect, the organic layer which is in direct contact with either or each of the main surfaces of the wavelength conversion layer is preferably the cured layer formed by curing a polymerizable composition containing the urethane bond-containing (meth)acrylate polymer.

According to one aspect of the urethane bond-containing (meth)acrylate polymer, a structural unit having an urethane bond is introduced to the side chain of the polymer. Hereinafter, a main chain to which the structural unit having an urethane bond is introduced will be described as the acryl main chain.

In addition, a (meth)acryloyl group is preferably contained at terminal of at least one of the side chains having an urethane bond. More preferably, every side chain having an urethane bond contains (meth)acryloyl group. Further preferably, the (meth)acryloyl group contained at the terminal is an acryloyl group.

The urethane bond-containing-(meth)acrylate polymer can be generally obtained by a graft-copolymerization, but is not particularly limited. The acryl main chain may be directly bonded to the structural unit having the urethane bond or may be bonded via a linkage group. Examples of the linkage group include ethylene oxide group, polyethylene oxide group, propylene oxide group, and polypropylene oxide group, and the like. The urethane bond containing-(meth)acrylate polymer may contain a plurality of kinds of side chain in which the structural units having urethane bond are bonded together via a different linkage group (including direct bond).

The urethane bond containing-(meth)acrylate polymer may have a side chain other than the structural unit having a urethane bond. An example of the other side chain is a linear or branched alkyl group. The linear or branched alkyl group is preferably a linear alkyl group of 1 to 6 carbon atoms, more preferably n-propyl group, ethyl group, or methyl group, and further preferably methyl group. In addition, the other side chain may contain other structure. This point also applies to the structural unit having a urethane bond.

The number of each of urethane bonds and (meth)acryloyl groups which are contained in one molecule of the urethane bond-containing-(meth)acrylate polymer is one or more, preferably two or more, but is not particularly limited. The weight-average molecular weight of the urethane bond-containing-(meth)acrylate polymer is preferably 10,000 or more, more preferably 12,000 or more, and further preferably 15,000 or more. Furthermore, the weight-average molecular weight of the urethane bond-containing-(meth)acrylate polymer is preferably 1,000,000 or less, more preferably 500,000 or less, and further preferably 300,000 or less. The acryl equivalent of the urethane bond containing-(meth)acrylate polymer is preferably 500 or more, more preferably 600 or more, and further preferably 700 or more; and the acryl equivalent is preferably 5,000 or less, more preferably 3,000 or less, and further preferably 2,000 or less. The acryl equivalent is a value obtained by dividing the weight-average molecular weight by the number of the (meth)acryloyl groups per one molecule.

As the urethane bond-containing-(meth)acrylate polymer, a polymer synthesized by a known method may be used, or a commercially available product may be used. Example of the commercially available product can include a UV curable acryl-urethane polymer (8BR series) manufactured by TAISEI Fine Chemical Co., Ltd. The urethane bond containing-(meth)acrylate polymer is preferably contained in an amount of 5 to 90% by mass relative to total solid content 100% by mass of the polymerizable composition for forming an organic layer, more preferably 10 to 80% by mass.

In the curable compound for forming an organic layer, one or more of the urethane bond containing-(meth)acrylate polymer and one or more of other polymerizable compound may be used together. As the other polymerizable compound, a compound having an ethylenic unsaturated bond at the terminal or side chain is preferable. Examples of the compound having the ethylenic unsaturated bond at the terminal or side chain include a (meth)acrylate compound, an acrylamide-based compound, a styrene-based compound, maleic anhydride, and the like; preferably a (meth)acrylate compound, more preferably an acrylate compound.

As the (meth)acrylate compound, (meth)acrylate, polyester (meth)acrylate, epoxy (meth)acrylate, and the like are preferable. Examples of the (meth)acrylate compound can include the compounds described in Paragraphs 0024 to 0036 of JP 2013-43382 A, or Paragraphs 0036 to 0048 of JP 2013-43384 A.

Styrene, α-methylstyrene, 4-methylstyrene, divinylbenzene, 4-hydroxystyrene, 4-caroxystyrene, and the like are preferable as the styrene compound.

The polymerizable composition for forming an organic layer can also contain a known additive together with one or more polymerizable compounds. Example of such an additive can include an organic metal coupling agent. For details, the above description can be referred to. The organic metal coupling agent is preferably contained in an amount of 0.1 to 30% by mass, more preferably 1 to 20% by mass, provided that the total solid content of the polymerizable composition used for forming an organic layer is set as 100% by mass.

In addition, an example of the additive includes a polymerization initiator. When the polymerization initiator is used, the content of the polymerization initiator in the polymerizable composition is preferably 0.1 mole % or more, more preferably 0.5 to 5 mole % relative to the total amount of the polymerizable compounds. Examples of the polymerization initiator include Irgacure series manufactured by BASF (for example, Irgacure 651, Irgacure 754, Irgacure 184, Irgacure 2959, Irgacure 907, Irgacure 369, Irgacure 379, Irgacure 819, etc.), Darocure series (for example, DarocureTPO, Darocure 1173, etc.), Quantacure PDO, Ezacure series manufactured by Lamberti (for example, Ezacure TZM, Ezacure TZT, Ezacure KT046, etc.), and the like.

The curing of the polymerizable composition for forming the organic layer may be performed by treatment (light irradiation, heating, and the like) appropriate to the type of the components (polymerizable compound, polymerization initiator) contained in the polymerizable composition. The curing conditions are not particularly limited, and may be set depending on the type of the components contained in the polymerizable composition and thickness of the organic layer, and the like.

For other details of the inorganic layer and the organic layer, the descriptions of JP 2007-290369 A, JP 2005-096108 A, and further US 2012/0113672 A1 can be referred to.

The inorganic layer and the organic layer, two organic layers, or two inorganic layers, may be stuck using an adhesive layer. From the viewpoint of enhancement of the light transmittance, the number of the adhesive layers is preferably small, and more preferably, there is no adhesive layer.

### (Light Scattering Function)

Wavelength conversion member may have a light scattering function to enable efficient extraction of fluorescence of the quantum dot. The light scattering function may be provided with the wavelength conversion layer, or a layer having light scattering function can be separately provided as a light scattering layer.

It is preferable to add light scattering particles in the wavelength conversion layer as one embodiment,

As another embodiment, it is preferable to provide a light scattering layer on the surface of the wavelength conversion layer. The scattering at the light scattering layer may be derived from the light scattering particles or surface having concave-convex structure the wavelength conversion layer.

### (Light Scattering Particles or the Like)

In the present description, “light scattering particles” means particles having a particle size of 0.10 μm (micrometer) or more. The light scattering is caused by optical unevenness in the layer. When particles having a sufficiently small particle size are contained, the optical evenness of the layer is not largely lowered, whereas the particles having a particle size of 0.10 μm (micrometer) or more are particles which make the layer optically uneven to thereby be able to scatter light. The light scattering particles are preferably contained in the wavelength conversion layer from the viewpoint of enhancing brightness.

The above-described particle size is a value obtained by observation through a scanning electron microscope (Scanning Electron Microscope; SEM). Specifically, after photographing the cross-section of the wavelength conversion layer by 5000 magnifications, a primary particle size is measured from the obtained photograph image. Additionally, in the case of a particle which is not spherical, an average value of a length of long axis and a length of short axis obtained is adopted as a primary particle size. The primary particle size thus obtained from such methods is set to be a particle size of the above-described particles. In addition, an average particle size of the light scattering particles is an arithmetic mean of particle sizes of 20 particles selected at random from among the particles having a particle size of 0.10 μm (micrometer) or more in the above-described photographed image. Note that the average particle size of the light scattering particles shown in the Examples described below is a value obtained by observing and measuring a cross-section of the wavelength conversion layer by using S-3400N manufactured by HITACHI Hi-Tech Instruments Co., Ltd. as the scanning Electron Microscope.

As described above, the particle size of the light scattering particle is 0.10 μm (micrometer) or more. From the viewpoint of the light scattering effect, the particle size of the light scattering particle is preferably within the range of 0.10 to 15.0 μm (micrometers), more preferably within the range of 0.10 to 10.0 μm (micrometers), and further preferably 0.20 to 4.0 μm (micrometers). Additionally, in order to further enhance the brightness and to control the brightness distribution to viewing angle, two or more of the light scattering particle having different particle sizes may be mixed.

The light scattering particle may be an organic particle or an inorganic particle, or an organic inorganic composite particle. An example of the organic particle includes a synthetic resin particle. Specific examples include a silicone resin particle, an acryl resin particle (polymethyl methacrylate (PMMA)), a Nylon resin particle, a styrene resin particle, polyethylene particle, urethane resin particle, benzoguanamine particle, and the like. From the viewpoint of the light scattering effect, the light scattering particle and other portion preferably have different refractive index in the organic matrix of the wavelength conversion layer, and in this regard, the silicone resin particle and the acryl resin particle are preferable from the viewpoint of the availability of the particle having a suitable refractive index. In addition, a particle of a hollow structure can also be used. Furthermore, a particle of diamond, titanium oxide, zirconium oxide, lead oxide, lead carbonate, zinc oxide, zinc sulfide, antimony oxide, silicon oxide, aluminum oxide, or the like can be used as the inorganic particle, and from the viewpoint of availability of the particle having a suitable refractive index, titanium oxide and aluminum oxide are preferable.

From viewpoint of the light scattering effect and the fragility of the wavelength conversion layer containing the particle, the light scattering particle is preferably contained, in the wavelength conversion layer, in an amount of 0.2% by volume or more on the basis of volume of the whole wavelength conversion layer which is set as 100% by volume, more preferably 0.2% by volume to 50% by volume, further preferably 0.2% by volume to 30% by volume, most preferably 0.2% by volume to 10% by volume.

In order to control the refractive index of the portions other than the light scattering particle in the organic matrix, a particle having a smaller particle size than the light scattering particle can be used as a refractive index controlling particle. A particle size of the refractive index controlling particle is less than 0.10 μm (micrometer).

Examples of the refractive index controlling particle include particles of diamond, titanium oxide, zirconium oxide, lead oxide, lead carbonate, zinc oxide, zinc sulfide, antimony oxide, silicon oxide, aluminum oxide, and the like. The refractive index controlling particle may be used in such an amount that the refractive index can be controlled, and the content in the wavelength conversion layer is not particularly limited.

### [Backlight Unit]

The backlight unit according to one aspect of the present invention includes at least the above-described wavelength conversion member and the light source. Details of the wavelength conversion member are as described above.

### (Light Emission Wavelength of Backlight Unit)

From the viewpoint of achieving high brightness and high color reproducibility, it is preferable to use a backlight unit having a multi wavelength light source. Preferred aspect is a backlight unit which emits;

a blue light having an emission center wavelength within the wavelength range of 430 to 480 nm and having an emission intensity peak with a half width of 100 nm or less, a green light having an emission center wavelength within the wavelength range of 500 to 600 nm and having an emission intensity peak with a half width of 100 nm or less,
a red light having an emission center wavelength within the wavelength range of 600 to 680 nm and having an emission intensity peak with a half width of 100 nm or less.

From the viewpoint of further enhancement of the high brightness and high color reproducibility, the wavelength range of the blue light which is emitted from the backlight unit is preferably within the range of 440 to 480 nm, more preferably within the range of 440 to 460 nm.

From the same point of view, the wavelength range of the green light which is emitted from the backlight unit is preferably within the range of 510 to 560 nm, more preferably within the range of 510 to 545 nm.

In addition, from the same point of view, the wavelength range of the red light which is emitted from the backlight unit is preferably within the range of 600 to 650 nm, more preferably within the range of 610 to 640 nm.

Additionally, from the same point of view, the half width of any emission intensity of the blue light, the green light and the red light which is emitted from the backlight unit is preferably 80 nm or less, more preferably 50 nm or less, further preferably 40 nm or less, and most preferably 30 nm or less. Among them, the half width of emission intensity of the blue light is particularly preferably 25 nm or less.

The backlight unit includes at least the light source together with the above-described wavelength conversion member. According to one aspect, a blue light source having an emission center wavelength within the wavelength range of 430 nm to 480 nm as the light source, for example, a blue light-emitting diode which emits a blue light can be used. When using the light source emitting blue light, the wavelength conversion layer preferably contains at least quantum dot A which is excited by exciting light to thereby emit red light, and quantum dot B which emits green light. Thereby, white light can be embodied by the blue light emitted from the light source and transmitted through the wavelength conversion member, and the red light and the green light emitted from the wavelength conversion member.

Alternatively, according to other aspect, a light source emitting an ultraviolet ray having an emission center wavelength within the wavelength range of 300 nm to 430 nm, for example, an ultraviolet ray-emitting diode can be used as the light source. In this case, the wavelength conversion layer preferably contains quantum dot C which is excited by exciting light to thereby emit blue light, together with quantum dots A and B. Thereby, white light can be embodied by the red light, the green light and the blue light emitted from the wavelength conversion member.

Furthermore, according to other aspect, the light-emitting diode can be replaced by a laser source.

### (Configuration of Backlight Unit)

The configuration of the backlight unit may be an edge light system using a light guide plate and a reflective plate as constituent members, and a direct under type system. FIGS. 1(a) and 1(b) show a backlight unit of the edge light system as one embodiment. A known plate can be used as the light guide plate, without any limitation.

Furthermore, the backlight unit may be provided with a reflective member in the rear of the light source. Such a reflective member is not particularly limited and a known member, which is described in JP3416302 B, JP3363565 B, JP4091978 B, JP3448626 B, or the like, can be used, and the contents of these publications are incorporated into the present invention.

The backlight unit is preferably provided with other known diffusion plate, a diffusion sheet, a prism sheet (for example, BEF series manufactured by SUMITOMO 3M), a light guide device. The other members are also described in the publications of JP3416302 B, JP3363565 B, JP4091978 B, JP3448626 B, and the like, the contents of these publications are incorporated into the present invention.

### [Liquid Crystal Display Device]

The liquid crystal display device according to one aspect of the present invention includes at least the above-described backlight unit and a liquid crystal cell.

### (Configuration of Liquid Crystal Display Device)

The driving mode of the liquid crystal cell is not particularly limited, and various modes such as twisted nematic (TN), super twisted nematic (STN), vertical alignment (VA), in-play-switching (IPS), and optically compensated bend cell (OCB) can be utilized. The liquid crystal cell is preferably VA mode, OCB mode, IPS mode or TN mode, but is not particularly limited thereto. One example of the configuration of the liquid crystal cell of VA mode is the configuration shown in FIG. 2 of JP 2008-262161 A. However, the specific configuration of the liquid crystal display device is not particularly limited, and a known configuration can be adopted.

One embodiment of the liquid crystal display device has a configuration in which the device includes a liquid crystal cell having a liquid crystal layer sandwiched between two opposing substrates at least one of which is provided with an electrode, and in which the liquid crystal cell is arranged between two polarizing plates. The liquid crystal display device has a liquid crystal cell where a liquid crystal is sealed between the upper and lower substrates and displays an image by changing a state of orientation of the liquid crystal through applying a voltage. Furthermore, as necessary, the device includes additional functional layers such as a polarizing plate protective film, an optically compensatory member which can perform optical compensation, and an adhesive layer. In addition, there may be arranged a color filter substrate, a thin layered transistor substrate, a lens film, a diffusion sheet, a hard coating layer, an antireflective layer, a low reflective layer, an antiglare layer, etc. and together (or instead thereof), a surface layer such as a forward scattering layer, a primer layer, an antistatic layer, or an under coating layer.

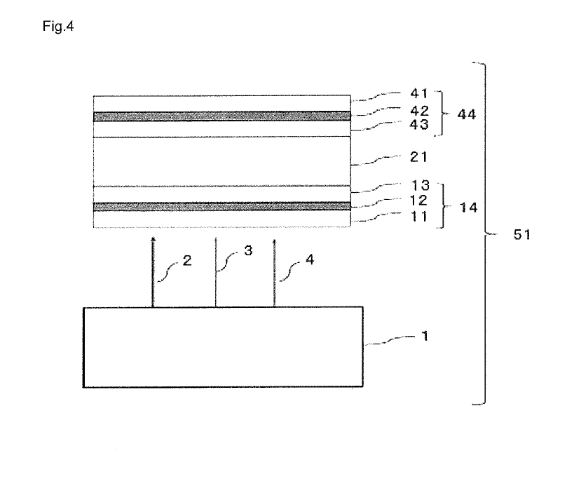

FIG. 4 shows one example of the liquid crystal display device according to one aspect of the present invention. The liquid crystal display device 51 shown in FIG. 2 has a backlight-side polarizing plate 14 on the surface of the backlight-side of the liquid crystal cell 21. The backlight side polarizing plate 14 may or may not include a polarizing plate protective film 11 on the surface of the backlight side of a backlight side polarizer 12, and preferably may include the protective film 11.

The backlight side polarizing plate 14 preferably has a configuration in which the polarizer 12 is sandwiched by the two polarizing plate protective films 11 and 13.

In the description, a polarizing plate protective film close to the liquid crystal cell with respect to the polarizer is referred to as an inner-side polarizing plate protective film, and a polarizing plate protective film apart from the liquid crystal cell with respect to the polarizer is referred to as an outer-side polarizing plate protective film. In the example shown in FIG. 2, the polarizing plate protective film 13 is the inner-side polarizing plate protective film, and the polarizing plate protective film 11 is the outer-side polarizing plate protective film.

The backlight-side polarizing plate may have a retardation film as an inner-side polarizing plate protective film on the liquid crystal cell side. A known cellulose acylate film can be used as such a retardation film.

The liquid crystal display device 51 has a display-side polarizing plate 44 on the surface opposite to the surface of the backlight side of the liquid crystal cell 21. The display-side polarizing plate 44 has a configuration in which a polarizer 42 is sandwiched by two polarizing plate protective films 41 and 43. The polarizing plate protective film 43 is the inner-side polarizing plate protective film, and the polarizing plate protective film 41 is the outer-side polarizing plate protective film.

The backlight unit 1 that the liquid crystal display device 51 has is as described above.

The liquid crystal cell, the polarizing plate, the polarizing plate protective film, and the like constituting the liquid crystal display device according to one aspect of the present invention are not particularly limited, and it is possible to use any one produced by a known method and a commercially available product without any limitation. In addition, a known medium layer such as an adhesive layer can naturally be provided between the layers.

Since the liquid crystal display device according to one aspect of the present invention as explained above has the backlight unit including the wavelength conversion member, the device can realize high brightness and high color reproducibility for a long period of time.

### EXAMPLE

Hereinafter, the present invention will be more specifically explained on the basis of Examples. The materials, use amounts, proportions, treatment contents, treatment procedures, and the like, shown in the following Examples can be appropriately modified as long as they do not depart from the gist of the present invention. Accordingly, the scope of the present invention should not be construed as being limited to the following Examples.

### Comparative Example 1

### 1. Preparation of Barrier Film 10

A barrier laminate was formed on one surface of a polyethylene terephthalate film (PET film, manufactured by TOYOBO Co., Ltd., Trade name: Cosmoshine (registered Trademark A4300, 50 μm thickness) in the following procedures.

TMPTA (trimethylolpropane triacrylate, manufactured by DAICEL-ALLNEX LTD.) and a photopolymerization initiator (ESACURE KT046, manufactured by Lamberti) were prepared, weighed in a weight ratio 95:5, and dissolved in methyl ethyl ketone to obtain an application liquid having a solid content of 15%. The application liquid was applied on the above-mentioned PET film by using a die coater by a roll-to-roll method, and made to pass through a drying zone of 50° C. for 3 minutes. The dried layer was irradiated with an ultraviolet ray (accumulated dosage 600 mJ/cm²) under a nitrogen atmosphere to achieve UV curing, and then wound up. The first organic layer formed on the supporting film (the above-mentioned PET film) had a thickness of 1 μm.

Next, an inorganic layer (silicon nitride layer) was formed on the surface of the organic layer by using a roll-to-roll CVD device. The raw material gases used were silane gas (flow rate 160 sccm (the standard condition at 0° C., 1 atm, hereinafter the same)), ammonia gas (flow rate 370 sccm), hydrogen gas (flow rate 590 sccm), and nitrogen gas (flow rate 240 sccm). A power source of high frequency of 13.56 MHz frequency was used as a power source. A film-forming pressure was 40 Pa, and a thickness achieved was 50 nm. In this manner, a barrier film 10 in which the organic layer and the inorganic layer were laminated on the supporting film in this order was produced.

### 2. Preparation of Quantum Dot-Containing Polymerizable Composition

The following quantum dot dispersion 1 was prepared, filtered with a filter made of polypropylene having a pore size of 0.2 μm, and then dried under a reduced pressure for 30 minutes, to be used as an application liquid

Quantum dot-containing polymerizable composition 1
(composition for organic layer 1 containing a quantum dot)

| | |
|---|---|
| Toluene dispersion of quantum dot 1 | 10.0 parts by mass |
| (maximum emission: 530 nm) | |
| Quantum dot 1: INP530-10 | |
| (manufactured by NN-labs) | |
| Toluene dispersion of quantum dot 2 | 1.0 part by mass |
| (maximum emission: 620 nm) | |
| Quantum dot 2: INP620-10 | |
| (manufactured by NN-labs) | |
| Lauryl methacrylate | 80.8 parts by mass |
| Trimethylolpropane triacrylate | 18.2 parts by mass |
| Photo polymerization initiator | 1 part by mass |
| (IRGACURE 819 (manufactured by BASF)) | |

(In the above, the quantum dot-concentrations in the toluene dispersions of the quantum dots 1, 2 were 1% by mass.)

### 3. Preparation of Wavelength Conversion Layer

A first barrier film 10 was prepared and while continuously conveying the first barrier film 10 at 1 m/min and under a tension of 60 N/m, the polymerizable composition 1 containing a quantum dot was applied, using a die coater, on the surface of the inorganic layer of the first barrier film 10 to form a coating film of 50 μm thickness. Subsequently, the first barrier film 10 on which the coating film was formed was wound on a backup roller, a second barrier film 10 was laminated on the coating film in a direction in which the surface of the inorganic layer was in contact with the coating film, and then, was wound on the backup roller in a state where the coating film was sandwiched by the first and second barrier films 10, and then irradiation with an ultraviolet ray was performed while continuously conveying the first and second barrier films 10.

A diameter of the backup roller was φ 300 mm, and a temperature of the backup roller was 50° C. Irradiation energy of the ultraviolet ray was 2000 mJ/cm². In addition, L1 was 50 mm, L2 was 1 mm, and L3 was 50 mm.

A cured layer (wavelength conversion layer) was formed by curing the coating layer through the above-mentioned ultraviolet ray irradiation to produce the laminated film (wavelength conversion member 101). The cured layer of the laminated film has a thickness of 50±2 μm. The accuracy of the thickness of the cured layer is as excellent as ±4%. In addition, generation of wrinkle was not observed on the laminated film.

In preparation of the quantum dot-containing polymerizable composition, wavelength conversion members 102 to 113 (Comparative Example 2, Examples 1 to 11) were produced in the same manner as that of the wavelength conversion member 101 (Comparative Example 1) except that each of the compounds (antioxidants) described in Table 1 was added in an amount of 1% by mass. Note that the “1% by mass” means 1% by mass relative to the total mass of the quantum dot-containing polymerizable composition after adding the antioxidant. Hereinafter, the same also applies to “% by mass”.

In preparation of the quantum dot-containing polymerizable composition, wavelength conversion members 114 to 117 (Examples 12 to 15) were produced in the same manner as that of the wavelength conversion member 101 (Comparative Example 1) except that the two compounds described in Table 1 were added, respectively.

### (Evaluation of Fresh Brightness)

A backlight unit was taken out by disassembling a commercially available tablet terminal (Kindle (registered trademark) Fire HDX 7″ manufactured by Amazon). The wavelength conversion member 101 to 117 cut into a rectangle was placed on the light guide plate of the backlight taken out, and two prism sheets in which the directions of the concave and convex surface patterns were orthogonally crossed were laid thereon. A brightness of light emitted from a blue light source and transmitted through the wavelength conversion member and the two prism sheets was measured by a luminance meter (SR3 manufactured by TOPCON) set at a position 740 mm apart in a vertical direction with respect to the light guide plate surface. Note that the measurement was carried out at the position 5 mm apart from a corner of the wavelength conversion member to an inner side, and the average value (Y0) of the measured values at the four corners was used as an evaluation value.

(Evaluation of Brightness after Continuous Irradiation)

In a room kept at a temperature of 25° C. and a relative humidity of 60%, each of the wavelength conversion members 101 to 117 was placed on a commercially available blue light source (OPSM-H150X142B manufactured by OPTEX-FA Kabushiki Kaisha), and the wavelength conversion member was continuously irradiated by the light source with blue light for 100 hours.

After continuous irradiation, the brightness (Y1) at the four corners of the wavelength conversion member was measured in the same manner as that of the evaluation of the brightness before continuous irradiation, respectively. An index of brightness change was obtained by calculating a change rate (ΔY) from the brightness value before continuous irradiation as described in the following equation. The results are shown in Table 1.

ΔY=(Y0−Y1)/Y0×100

### (Evaluation of Curability)

Evaluation was carried out in accordance with the following criteria by pushing a film surface of the wavelength conversion members 101 to 117 with a finger and by visually observing whether or not a pushed trace remains. The results are shown in Table 1.

A: Any pushed trace did not remain in the sample cured at a UV irradiation energy of 2000 mJ/cm².
B: A pushed trace remained in the sample when cured at a UV irradiation energy of 2000 mJ/cm², but after that, any pushed trace did not remain in the sample when further cured at a UV irradiation energy of 2000 mJ/cm².

### (Preparation of Sample for Evaluation of Coloring)

A sample for evaluation of coloring corresponding to the wavelength conversion member 101 was obtained by forming a coating film and performing irradiation with a ultraviolet ray in the same manner as that of the wavelength conversion member 101 except a polyethylene terephthalate film (PET film, manufactured by TOYOBO Co., Ltd., Trade name: Cosmoshine A4300, 50 μm thickness) was used instead of the barrier film 10 as the base material, and a polymerizable composition 2 to which the toluene solution of the quantum dot was not added as described below as the polymerizable composition.

Polymerizable composition 2
(Preparation of sample for evaluation of coloring)

| | |
|---|---|
| Lauryl methacrylate | 80.8 parts by mass |
| Trimethylolpropane triacrylate | 18.2 parts by mass |
| Photo polymerization initiator | 1 part by mass |
| (IRGACURE 819 (manufactured by BASF)) | |

Samples for evaluating coloring corresponding to the wavelength conversion members 102 to 113 were obtained by forming a coating film and performing irradiation with a ultraviolet ray in the same manner as that of the wavelength conversion member 101 (Comparative Example 1) except that each of the compounds (antioxidants) described in Table 1 was added in an amount of 1% by mass in preparation of the polymerizable composition 2.

Samples for evaluating coloring corresponding to the wavelength conversion members 114 to 117 were obtained by forming a coating film and performing irradiation with a ultraviolet ray in the same manner as that of the wavelength conversion member 101 (Comparative Example 1) except that the two compounds described in Table 1 were added in amounts shown in Table 1, respectively, in preparation of the polymerizable composition 2.

### (Evaluation of Coloring)

The coloring of the samples for evaluating coloring corresponding to the wavelength conversion members 101 to 117 was evaluated in accordance with the following criteria, by measuring an average value of transmittance over a visible light region (380 nm to 780 nm). The results are shown in Table 1.

A: Transmittance was 92% or more
B: Transmittance was 90% or more and less than 92%
C: Transmittance was less than 90%

TABLE 1

| | | | | Bright- | | |
|---|---|---|---|---|---|---|
| | | | | ness | | |
| | | | Amount | change | | |
| | | | added | rate | Cura- | Color- |
| | | Compound (antioxidant) | (mass %) | (ΔY) | bility | ing |
| Compara- | Wavelength | None | | 75 | A | A |
| tive | conversion | | | | | |
| example 1 | member 101 | | | | | |
| Compara- tive example 2 | Wavelength conversion member 102 | 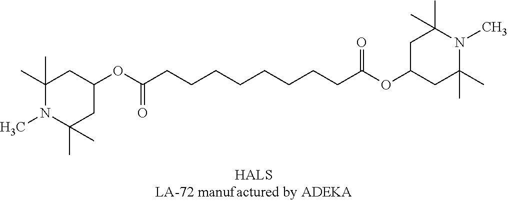 | 1 | 25 | B | C |
| Example 1 | Wavelength | B-2 | 1 | 24 | A | B |
| | conversion | | | | | |
| | member 103 | | | | | |
| Example 2 | Wavelength | B-13 | 1 | 25 | A | A |
| | conversion | | | | | |
| | member 104 | | | | | |
| Example 3 | Wavelength | B-17 | 1 | 10 | A | A |
| | conversion | | | | | |
| | member 105 | | | | | |
| Example 4 | Wavelength | TI-2 | 1 | 14 | A | A |
| | conversion | | | | | |
| | member 106 | | | | | |
| Example 5 | Wavelength | TI-17 | 1 | 13 | A | A |
| | conversion | | | | | |
| | member 107 | | | | | |
| Example 6 | Wavelength | TIII-13 | 1 | 26 | A | A |
| | conversion | | | | | |
| | member 108 | | | | | |
| Example 7 | Wavelength | TIV-2 | 1 | 14 | A | A |
| | conversion | | | | | |
| | member 109 | | | | | |
| Example 8 | Wavelength | TIV-3 | 1 | 28 | A | A |
| | conversion | | | | | |
| | member 110 | | | | | |
| Example 9 | Wavelength | TIV-4 | 1 | 24 | A | A |
| | conversion | | | | | |
| | member 111 | | | | | |
| Example 10 | Wavelength | TIV-6 | 1 | 23 | A | A |
| | conversion | | | | | |
| | member 112 | | | | | |
| Example 11 | Wavelength | TIV-12 | 1 | 21 | A | A |
| | conversion | | | | | |
| | member 113 | | | | | |
| Example 12 | Wavelength | B-17 | 0.8 | 7 | A | A |
| | conversion | TI-2 | 0.2 | | | |
| | member 114 | | | | | |
| Example 13 | Wavelength | B-17 | 0.8 | 7 | A | A |
| | conversion | TIV-3 | 0.2 | | | |
| | member 115 | | | | | |
| Example 14 | Wavelength | B-17 | 0.95 | 9 | A | A |
| | conversion | TI-6 | 0.05 | | | |
| | member 116 | | | | | |
| Example 15 | Wavelength | B-17 | 0.8 | 7 | A | A |
| | conversion | TIV-17 | 0.2 | | | |
| | member 117 | | | | | |

While the present invention has been described in detail and with reference to specific embodiments thereof, it will be apparent to one skilled in the art that various changes and modifications can be made therein without departing from the spirit and scope thereof. All the publications referred to in the present specification are expressly incorporated herein by reference in their entirety. The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

While the present invention has been described in detail and with reference to specific embodiments thereof, it will be apparent to one skilled in the art that various changes and modifications can be made therein without departing from the spirit and scope thereof. All the publications referred to in the present specification are expressly incorporated herein by reference in their entirety. The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

### KEY TO THE NUMBERS

1 backlight unit
1A light source
1B light guide plate
100 manufacturing apparatus
10 first film
20 application portion
22 coating film
24 die coater
26 backup roller
28 cured layer
30 laminating portion
32 laminate roller
34 heating chamber
50 second film
60 treatment portion
62 backup roller
64 light irradiation device
70 wavelength conversion member (laminated film)
80 peeling roller

1. A wavelength conversion member comprising a wavelength conversion layer comprising a quantum dot which is excited by exciting light to emit fluorescence, wherein
the wavelength conversion layer comprises an organic matrix, and
the organic matrix comprises a polymer and one or more of compounds selected from the group consisting of compounds represented by any of the following general formulae (1) to (6); 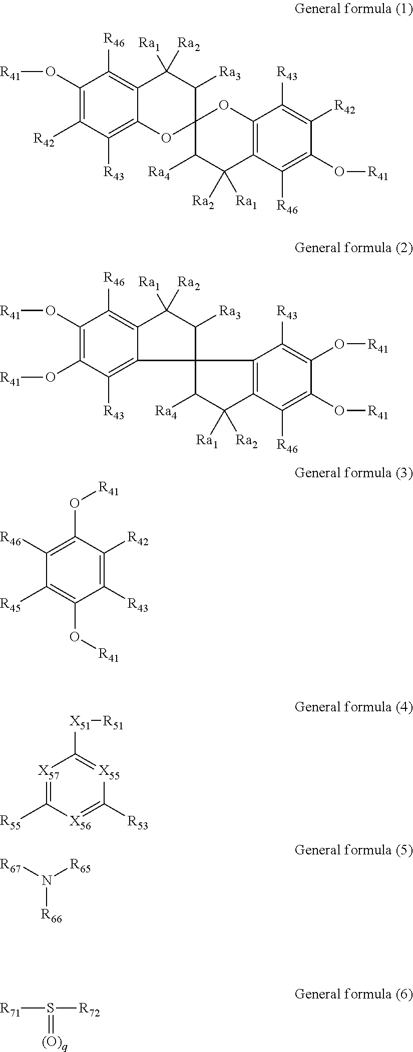
in general formulae (1) to (3), R₄₁ represents an aliphatic group, an aryl group, a heterocyclic group, an acyl group, an aliphatic oxycarbonyl group, an aryloxycarbonyl group, an aliphatic sulfonyl group, an aryl sulfonyl group, a phosphoryl group or —Si(R₄₇)(R₄₈)(R₄₉), each of R₄₇, R₄₈ and R₄₉ represents independently an aliphatic group, an aryl group, an aliphatic oxy group or an aryloxy group, each of R₄₂ to R₄₆ represents independently hydrogen atom or a substituent, and each of Rₐ₁ to Rₐ₄ represents independently hydrogen or an aliphatic group,
in general formula (4), R₅₁ represents hydrogen atom, an aliphatic group, an aryl group, a heterocyclic group, an acyl group, an aliphatic oxycarbonyl group, an aryloxycarbonyl group, an aliphatic sulfonyl group, an aryl sulfonyl group, a phosphoryl group or —Si(R₅₈)(R₅₉)(R₆₀), each of R₅₈, R₅₉ and R₆₀ represents independently an aliphatic group, an aryl group, an aliphatic oxy group or an aryloxy group, X₅₁ represents —O— or —N(R₅₇)—, R₅₇ has the same definition as that of R₅₁, X₅₅ represents —N═ or —C(R₅₂)═, X₅₆ represents —N═ or —C(R₅₄)=, X₅₇ represents —N═ or —C(R₅₆)=, each of R₅₂, R₅₃, R₅₄, R₅₅ and R₅₆ represents independently hydrogen atom or a substituent, R₅₁ and R₅₂, R₅₇ and R₅₆, and R₅₁ and R₅₇ may be bonded to each other to form a 5- to 7-membered ring, R₅₂ and R₅₃, R₅₃ and R₅₄ may be bonded to each other to form a 5- to 7-membered ring or a spiro ring, a bicycle ring, provided that not all of R₅₁ to R₅₇ are hydrogen atoms at the same time, the total number of carbon atoms of the compounds represented by general formula (4) is 10 or more, and the compounds represented by general formula (4) are not the compounds represented by any of general formulae (1) to (3),
in general formula (5), each of R₆₅ and R₆₆ represents independently hydrogen atom, an aliphatic group, an aryl group, an acyl group, an aliphatic oxycarbonyl group, an aryloxycarbonyl group, a carbamoyl group, an aliphatic sulfonyl group or an aryl sulfonyl group, R₆₇ represents hydrogen atom, an aliphatic group, an aliphatic oxy group, an aryloxy group, an aliphatic thio group, an aryl thio group, an acyloxy group, an aliphatic oxycarbonyloxy group, an aryloxycarbonyloxy group, a substituted amino group, a heterocyclic group or hydroxyl group, R₆₅ and R₆₆, R₆₆ and R₆₇, and R₆₅ and R₆₇ may be bonded to each other to form 5- to 7-membered ring, but do not form a 2,2,6,6-tetraalkylpiperidine skeleton, not both of R₆₅ and R₆₆ are hydrogen atoms at the same time, and the total number of carbon atoms of R₆₅ and R₆₆ is 7 or more,
in general formula (6), R₇₁ represents hydrogen atom, an aliphatic group, an aryl group, a heterocyclic group, Li, Na or K, R₇₂ represents an aliphatic group, an aryl group or a heterocyclic group, R₇₁ and R₇₂ may be bonded to each other to form a 5- to 7-membered ring, q represents 0, 1 or 2, provided that the total number of carbon atoms of R₇₁ and R₇₂ is 10 or more.

2. The wavelength conversion member according to claim 1, wherein the compounds represented by any of general formulae (1) to (6) are compounds represented by any of general formulae (1) to (3).

3. The wavelength conversion member according to claim 1, wherein the compounds represented by any of general formulae (1) to (6) are compounds represented by any of general formulae (4) to (6).

4. The wavelength conversion member according to claim 1, wherein the compounds represented by any of general formulae (1) to (6) are compounds represented by general formula (6).

5. The wavelength conversion member according to claim 1, wherein the polymer is a polymer of a (meth)acrylate monomer.

6. The wavelength conversion member according to claim 1, wherein the polymer is a polymer of a mono-functional (meth)acrylate monomer and a poly-functional (meth) acrylate monomer.

7. The wavelength conversion member according to claim 1, comprising a base material, and at least one surface of the wavelength conversion layer is directly in contact with the base material.

8. The wavelength conversion member according to claim 7, comprising two base materials each of which is a barrier film comprising an inorganic layer, and comprising the wavelength conversion layer between the two barrier films.

9. The wavelength conversion member according to claim 8, wherein each of the two barrier films is directly in contact with the wavelength conversion layer at the inorganic layer.

10. The wavelength conversion member according to claim 8, wherein an oxygen permeability of each of the barrier film is 1 cm³/(m²·day·atm) or less.

11. The wavelength conversion member according to claim 1, wherein the wavelength conversion layer comprises a first quantum dot having a emission center wavelength in 500 nm to 600 nm, and a second quantum dot having a emission center wavelength in 600 to 680 nm.

12. A backlight unit comprising at least the wavelength conversion member according to claim 1 and a light source.

13. The backlight unit according to claim 12, wherein the light source is a blue light emission diode or an ultraviolet ray emission diode.

14. The backlight unit according to claim 12, further comprising a light guide plate, wherein the wavelength conversion member is arranged on a path of light emitted from the light guide plate.

15. The backlight unit according to claim 12, further comprising a light guide plate, wherein
the wavelength conversion member is arranged between the light guide plate and the light source.

16. A liquid crystal display device comprising at least the backlight unit according to claim 12 and a liquid crystal cell.

17. A quantum dot-containing polymerizable composition comprising a quantum dot which is excited by exciting light to emit fluorescence, a radical polymerizable compound, and one or more of compounds selected from the group consisting of compounds represented by any of the following general formulae (1) to (6); 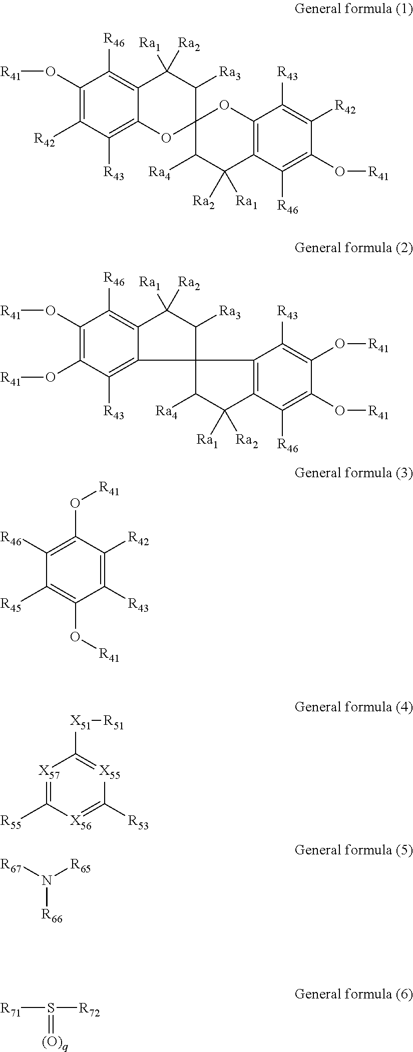
in general formulae (1) to (3), R₄₁ represents an aliphatic group, an aryl group, a heterocyclic group, an acyl group, an aliphatic oxycarbonyl group, an aryloxycarbonyl group, an aliphatic sulfonyl group, an aryl sulfonyl group, a phosphoryl group or —Si(R₄₇)(R₄₈)(R₄₉), each of R₄₇, R₄₈ and R₄₉ represents independently an aliphatic group, an aryl group, an aliphatic oxy group or an aryloxy group, each of R₄₂ to R₄₆ represents independently hydrogen atom or a substituent, and each of Rₐ₁ to Rₐ₄ represents independently hydrogen atom or an aliphatic group,
in general formula (4), R₅₁ represents hydrogen atom, an aliphatic group, an aryl group, a heterocyclic group, an acyl group, an aliphatic oxycarbonyl group, an aryloxycarbonyl group, an aliphatic sulfonyl group, an aryl sulfonyl group, a phosphoryl group or —Si(R₅₈)(R₅₉)(R₆₀), each of R₅₈, R₅₉ and R₆₀ represents independently an aliphatic group, an aryl group, an aliphatic oxy group or an aryloxy group, X₅₁ represents —O— or —N(R₅₇)—, R₅₇ is the same as R₅₁, X₅₅ represents —N═ or —C(R₅₂)═, X₅₆ represents —N═ or —C(R₅₄)═, X₅₇ represents —N═ or —C(R₅₆)═, each of R₅₂, R₅₃, R₅₄, R₅₅ and R₅₆ represents independently hydrogen atom or a substituent, R₅₁ and R₅₂, R₅₇ and R₅₆, and R₅₁ and R₅₇ may be bonded to each other to form a 5- to 7-membered ring, R₅₂ and R₅₃, and R₅₃ and R₅₄ may be bonded to each other to form a 5- to 7-membered ring or a Spiro ring, a bicycle ring, provided that not all of R₅₁ to R₅₇ are hydrogen atoms at the same time, the total number of carbon atoms of the compounds represented by general formula (4) is 10 or more, and the compounds represented by general formula (4) are not the compounds represented by any of general formulae (1) to (3),
in general formula (5), each of R₆₅ and R₆₆ represents independently hydrogen atom, an aliphatic group, an aryl group, an acyl group, an aliphatic oxycarbonyl group, an aryloxycarbonyl group, a carbamoyl group, an aliphatic sulfonyl group or an aryl sulfonyl group, R₆₇ represents hydrogen atom, an aliphatic group, an aliphatic oxy group, an aryloxy group, an aliphatic thio group, an aryl thio group, an acyloxy group, an aliphatic oxycarbonyloxy group, an aryloxycarbonyloxy group, a substituted amino group, a heterocyclic group or a hydroxyl group, R₆₅ and R₆₆, R₆₆ and R₆₇, and R₆₅ and R₆₇ may be bonded to each other to form 5- to 7-membered ring, but do not form a 2,2,6,6-tetraalkylpiperidine skeleton, not both of R₆₅ and R₆₆ are hydrogen atoms at the same time, and the total number of carbon atoms of R₆₅ and R₆₆ is 7 or more, in general formula (6), R₇₁ represents hydrogen atom, an aliphatic group, an aryl group, a heterocyclic group, Li, Na or K, R₇₂ represents an aliphatic group, an aryl group or a heterocyclic group, R₇₁ and R₇₂ may be bonded to each other to form a 5- to 7-membered ring, q represents 0, 1 or 2, provided that the total number of carbon atoms of R₇₁ and R₇₂ is 10 or more.

18. The quantum dot-containing polymerizable composition according to claim 17, comprising a (meth)acrylate monomer as the radical polymerizable compound.

19. The quantum dot-containing polymerizable composition according to claim 18, comprising a mono-functional (meth)acrylate monomer and a poly-functional (meth) acrylate monomer as the radical polymerizable compound.

20. The quantum dot-containing polymerizable composition according to claim 19, wherein the mono-functional (meth)acrylate monomer has a long-chain alkyl group of 4 to 30 carbon atoms.
